(19) United States
(12) Patent Application Publication
(10) Pub. No.: US 2007/0014214 A1
(43) Pub. Date: Jan. 18, 2007

(54) Quantum cipher recording method, and quantum cipher recording device

(75) Inventor: Katsuya Nozawa, Osaka-shi (JP)

Correspondence Address: RATNERPRESTIA, P O BOX 980, VALLEY FORGE, PA, 19482-0980, US

(73) Assignee: Matsushita Electric Industrial Co., Ltd.

(21) Appl. No.: 11/167,527

(22) Filed: Jun. 27, 2005

(30) Foreign Application Priority Data
Jul. 16, 2004 (JP) 2004-209516

(51) Int. Cl. G11B 5/09

(52) U.S. Cl. 369/47.1

(57) ABSTRACT

An information recording/reproducing method comprises several steps. Information to be recorded, a reading key that allows a person knowing the key to specify a base used for recording each bit and inhibits a person unknowing it from specifying the base, and an algorithm for determining the base from the key are prepared. A state to be created for each bit from quantum states is selected so as to satisfy the conditions. A measured value corresponding to the information to be recorded is acquired when a reading procedure corresponding to each base is performed. The measured value is not acquired when unitary transformation corresponding to a different base is performed. The quantum state in the recording medium is created. The state is kept, and each base is determined according to the key and performing the reading procedure corresponding to the base. Safety of the recorded information can be sufficiently secured.

### BACKGROUND OF THE INVENTION

1. Field of the Invention

The present invention relates to a recording method of information.

2. Background Art

Various information has been presently recorded in an electronically accessible recording medium and used.

The information in the recording medium is stored as difference in a physical state of the physical medium. The difference is as follows:
directions of magnetization on a magnetic tape or a hard disk;
a crystal state or an amorphous state in a digital versatile disk (DVD)-random access memory (RAM);
presence or absence of a hole in a compact disk (CD); or
charge amount held in dynamic RAM (DRAM).
   In a digital manner, values of the recorded information are usually assigned to two distinguishable physical states (S0 and S1). For example, in the DRAM, “1” is assigned to a charge stored state, and “0” is assigned to a charge non-stored state.

“Writing” means generating a state corresponding to information to be recorded, and a writing device performs this operation. “Reading” means detecting a state of the physical medium, namely measuring a physical quantity used for specifying a physical state, and a reading device performs this operation.

At this time, the measurement of physical quantity must result in a specific value corresponding to the state of the physical medium. For example, value V0 must be acquired when state S0 is measured, and value V1 must be acquired when state S1 is measured. Value V0 must not be acquired when state S1 is measured, and a value other than V0 and V1 must not be acquired though information is recorded. Values V0 and V1 may have a width. For example, in the DRAM, the stored charge is measured as voltage, value V0 is set when the voltage is 1V or higher, and value V1 is set when the voltage is 0.1V or lower. When the state can be identified, the recorded information can be read based on the assignment relation between the state and the information. This process is a conventional basic flow of recording the information.

As shown in FIG. 1, in the conventional recording method, there is a one-to-one relationship among recorded information, a physical state corresponding to the information, a physical value acquired by measuring the physical state, and read information. In other words, all of the recorded state and the recorded information can be uniquely specified based on the read information.

The electronically recorded information includes much information of which contents are not intended to be known by a person other than an authorized information user. Here, the information is related to finance or individual privacy. A cash card or a credit card can be invalidly used regardless of whether the recorded contents are explicitly read, because the recorded information is used for authenticating the right of account use or purchasing contract. Thus, when the contents are copied, the authorized user gets a drawback. The recorded information must be protected.

There are mainly two information protecting methods. The first method gives reading permission to only the authorized information user, and the second method is called mathematical encryption.

In the first method, the safety is secured by adding an authenticating mechanism to a reading device and permitting the measurement of physical quantity only in an authenticating case. When only this method is performed, however, the information is easily leaked by tampering, namely unauthorized information user bypasses the authenticating mechanism and directly measures the state of the physical medium. The tampering is described in detail in “Investigation related to safety of smart card, fiscal 1999” Information-technology Promotion Agency.

Therefore, generally, mathematical encryption technology is also used.

In the mathematical encryption technology, information (plain text) that is not intended to be known by an unauthorized information user is transformed, by a mathematical operation called encryption, to information (cipher text) from which the contents of the plain text cannot be estimated at first glance.

One example of the mathematical encryption is described below.

The plain text is assumed as the text in “ ” of “This is a pen.” (ending in one blank). This plain text is described in binary notation with ASCII code as follows,

| | | |
|---|---|---|
| 1010100 | 1101000 | 1101001 |
| 1110011 | 0100000 | 1101001 |
| 1110011 | 0100000 | 1100001 |
| 0100000 | 1110000 | 1100101 |
| 1101110 | 0101110 | 0100000. |

Seven bits between blanks correspond to one ASCII code, codes are arranged in a left-to-right fashion, and a new line is started every 21 bits. This representation is employed hereinafter, except where specifically noted.

For performing the mathematical encryption, other data called a key is prepared in addition to the plain text. A keyword method, namely a method using a character string as the key data, is described here. For example,

KEY

is assumed to be the key (keyword). This key is described in binary notation with ASCII code as follows,

| | | |
|---|---|---|
| 1001011 | 1000101 | 1011001. |

The plain text is formed of 15 characters and the key is formed of 3 characters, so that the key must be extended to match the length of the plain text with that of the key. As the simplest example, the binary notation is repeated five times. In other words, the key is represented as

| | | |
|---|---|---|
| 1001011 | 1000101 | 1011001 |
| 1001011 | 1000101 | 1011001 |
| 1001011 | 1000101 | 1011001 |
| 1001011 | 1000101 | 1011001 |
| 1001011 | 1000101 | 1011001. |

When the simple repetition is performed in an actual cipher, the periodicity provides a clue about unauthorized decryption. Therefore, an extending method of which periodicity is further hardly noticed is usually employed. However, the periodicity does not affect the following description and hence the simplest method is described.

The bits of the plain text and the bits of the key are compared with each other position-by-position. “0” is set when each bit of the plain text is the same as that of the key, and “1” is set when each bit of the plain text is different from that of the key. In other words, exclusive OR (XOR) of corresponding bits is represented as

| | | |
|---|---|---|
| 0011111 | 0101101 | 0110000 |
| 0111000 | 1100101 | 0110000 |
| 0111000 | 1100101 | 0111000 |
| 1101011 | 0110101 | 0111100 |
| 0100101 | 1101011 | 1111001. |

This is the cipher text represented in binary notation. This information is recorded in a recording medium.

In other words, the state

| | | |
|---|---|---|
| S0, S0, S1, S1, S1, S1, S1 | S0, S1, S0, S1, S1, S0, S1 | S0, S1, S1, S0, S0, S0, S0 |
| S0, S1, S1, S1, S0, S0, S0 | S1, S1, S0, S0, S1, S0, S1 | S0, S1, S1, S0, S0, S0, S0 |
| S0, S1, S1, S1, S0, S0, S0 | S1, S1, S0, S0, S1, S0, S1 | S0, S1, S1, S1, S0, S0, S0 |
| S1, S1, S0, S1, S0, S1, S1 | S0, S1, S1, S0, S1, S0, S1 | S0, S1, S1, S1, S1, S0, S0 |
| S0, S1, S0, S0, S1, S0, S1 | S1, S1, S0, S1, S0, S1, S1 | S1, S1, S1, S1, S0, S0, S1 |

is created and stored in a physical medium.

When the state is read from this physical medium, each value of physical quantity

| | | |
|---|---|---|
| V0, V0, V1, V1, V1, V1, V1 | V0, V1, V0, V1, V1, V0, V1 | V0, V1, V1, V0, V0, V0, V0 |
| V0, V1, V1, V1, V0, V0, V0 | V1, V1, V0, V0, V1, V0, V1 | V0, V1, V1, V0, V0, V0, V0 |
| V0, V1, V1, V1, V0, V0, V0 | V1, V1, V0, V0, V1, V0, V1 | V0, V1, V1, V1, V0, V0, V0 |
| V1, V1, V0, V1, V0, V1, V1 | V0, V1, V1, V0, V1, V0, V1 | V0, V1, V1, V1, V1, V0, V0 |
| V0, V1, V0, V0, V1, V0, V1 | V1, V1, V0, V1, V0, V1, V1 | V1, V1, V1, V1, V0, V0, V1 |

is obtained.

When the physical quantity is interpreted based on the correspondence between the measured values of physical quantity and the information, the recorded cipher text

| | | |
|---|---|---|
| 0011111 | 0101101 | 0110000 |
| 0111000 | 1100101 | 0110000 |
| 0111000 | 1100101 | 0111000 |
| 1101011 | 0110101 | 0111100 |
| 0100101 | 1101011 | 1111001 |

is obtained. This cipher text can be leaked by the tampering or the like.

However, when this cipher text is interpreted as it is with ASCII code,

−08e08e8k5<%ky

is obtained. This makes no sense.

The recording medium where a cipher text is recorded, the fact that the key is “KEY”, and a decrypting procedure are disclosed to the authorized information user. The cipher text can be read similarly to usual information, so that each bit of the read cipher text in the ASCII notation is compared with each bit of the key extended to the length equal to that of the cipher text in the ASCII notation. “0” is set when mutually corresponding bits are the same, and “1” is set when mutually corresponding bits are not the same. The set result is interpreted according to the ASCII code, and thus the plain text can be easily reproduced. This process means the decryption of the mathematical cipher.

While, it is assumed that an unauthorized information user does not know the key but can access the cipher text in the recording medium by tampering or the like. The cipher text is information making no sense as it is, so that the decryption of the mathematical cipher is required. The algorithm of the decryption is generally known, so that the user can try the decryption using an appropriate character string as the key. For example, when

BAD

is used as a key candidate and a procedure same as the decryption is tried,

]ltz$tz$|)txg*=

is obtained as a plain text candidate. This makes no sense as a document. In other words, this candidate has not a characteristic to be possessed as a plain text. The unauthorized information user considers that the unauthorized decryption has ended in failure, and repeats unauthorized decryption with the other key candidates until the user obtains a result making sense as a plain text.

In the cipher example discussed above, when the key has a length equal to the length of the plain text and is formed of a hitherto unused true random string, the unauthorized decryption is known to be impossible in principle. The plain text candidates include all texts (data strings) represented with the number of bits and hence all candidates having a characteristic to be possessed as a plain text, so that a correct plain text cannot be specified from all candidates. Thus, the absence of the key information disables any information from being extracted from the cipher text, and this state is called perfect secrecy.

However, actually, even when there is no key information, much time and many calculations often allow the decryption (unauthorized decryption). For perfect secrecy, practical restriction such as sharing of large numbers of hard-to-remember keys is imposed.

A short key such as the keyword discussed above is therefore employed. When the unauthorized information user has known that the keyword is three or less letters of the alphabet, for example, the unauthorized user can try to decrypt the cipher text using key candidates in a round-robin manner. When a characteristic possessed as a plain text is obtained, this plain text can be estimated as a correct plain text. When the length of the key is sufficiently shorter than that of the plain text, possibility of obtaining a text that is not the correct plain text but has a characteristic as a plain text at a decryption time becomes extremely small. In the example discussed above, there is little possibility of obtaining a meaningful text when a cipher text is decrypted using keys other than “KEY”. Therefore, it is determined that “KEY” is the correct key and “This is a pen.” is the correct plain text in this method.

The safety in this case is guaranteed by assuming that extremely much time and extremely large calculation amount are required for unauthorized decryption and the unauthorized decryption cannot be achieved within a time period over which the information is meaningful. Such mathematical encryption is described in detail in “Introduction to Cipher and Stochastic Algorithm” by H. Delfs and H. Knebl, Springer-Verlag Tokyo.

The safety of mathematical encryption that is not completely concealed is guaranteed only when the time period until success in unauthorized decryption is longer than the time period over which the information is worthful. The time required for the unauthorized decryption largely depends on the information processing technology. The progression of the information processing technology may cause a cipher that is considered to be effectively safe at a using start time to become effectively unsafe in the future within a time period over which the information is worthful. Here, the information processing technology includes speeding up of computers and discovery of an efficient unauthorized decryption algorithm.

The safety of information by a mathematical cipher always includes risk of sudden breakage due to the progression of the information processing technology or risk of use of the cipher without noticing actual breakage of the safety.

A card for authentication can be invalidly used when information recorded in the card can be simply copied accurately, even when the unauthorized decryption of the recorded cipher text is not achieved. The mathematical encryption cannot overcome such copy.

### SUMMARY OF THE INVENTION

The present invention provides an information recording/reproducing method comprising steps of:
preparing the following elements:
   information to be recorded;
   information called a reading key that allows a person knowing the key to specify a base used for recording each bit and inhibits a person who does not know the key from specifying the base; and
   an algorithm for determining the base of each bit from the reading key;
selecting a state to be created for each bit from a set of quantum states selected so as to satisfy the following conditions:
   a measured value corresponding to the information to be recorded is acquired when a reading procedure corresponding to each base is performed; and
   the measured value corresponding to the information to be recorded is not acquired when unitary transformation corresponding to a different base is performed;
creating the quantum state in the recording medium;
keeping the state; and
determining the base of each bit according to the reading key and performing the reading procedure corresponding to the base.

When the information recording method of the present invention is used, risk of unauthorized decryption of the information by an unauthorized information user or risk of copy of the information can be reduced.

### BRIEF DESCRIPTION OF THE DRAWINGS

FIG. 1 is a diagram showing a relation between information and states in a conventional recording method.

FIG. 2 is a diagram showing a relation between eigen-states and measured values.

FIG. 3 is a diagram showing a relation between superposition states and measured values.

FIG. 4 is a diagram showing a measured value and possible states before measurement.

FIG. 5 is a diagram showing a quantum cipher writing device, a decrypting device, a reading device, and a recording medium in accordance with a first exemplary embodiment of the present invention.

FIG. 6 is a diagram showing a quantum cipher writing device, a decrypting device, a reading device, and a recording medium (transistor configuration) in accordance with the first exemplary embodiment of the present invention.

FIG. 7 is a diagram showing recorded states and a decrypting procedure.

FIG. 8 is a diagram showing incorrect decryption.

FIG. 9 is a diagram showing a decrypting procedure and a relation between obtained measured values and information (an operation corresponding to base A is performed).

FIG. 10 is a diagram showing a decrypting procedure and a relation between obtained measured values and information (an operation corresponding to base B is performed).

FIG. 11 is a diagram showing bit substitution.

FIG. 12 is a diagram showing a quantum cipher writing device, a decrypting device, a reading device, and a recording medium in accordance with a second exemplary embodiment of the present invention.

FIG. 13 is a diagram showing a relation between phase states.

FIG. 14 is a diagram showing a relation between the phase states and reading phases.

FIG. 15 is a diagram showing a quantum cipher writing device, a decrypting device, a reading device, and a recording medium in accordance with a third exemplary embodiment of the present invention.

FIG. 16 is a diagram showing a quantum cipher writing device, a decrypting device, a reading device, and a recording medium (transistor configuration) in accordance with the third exemplary embodiment of the present invention.

FIG. 17 is a diagram showing time change of a coupled quantum dot.

FIG. 18 is a diagram showing possibility of finding an extra electron in a second quantum dot at each phase time.

FIG. 19 is a diagram showing a quantum cipher writing device, a decrypting device, a reading device, and a recording medium in accordance with a fourth exemplary embodiment of the present invention.

FIG. 20 is a diagram showing a quantum cipher writing device, a decrypting device, a reading device, and a recording medium (transistor configuration) in accordance with a fifth exemplary embodiment of the present invention.

FIG. 21 is a diagram showing a relation between the phase states and reading phases.

FIG. 22 is a diagram showing a molecule having two eigen-states.

FIG. 23 is a diagram showing vectors representing quantum ensembles.

FIG. 24 is a diagram showing an effect of measurement on a quantum ensemble.

FIG. 25 is a diagram showing a quantum cipher writing device, a decrypting device, a reading device, and a recording medium in accordance with a sixth exemplary embodiment of the present invention.

FIG. 26 is a diagram showing a quantum ensemble state (base A) to which information is assigned.

FIG. 27 is a diagram showing a quantum ensemble state (base B) to which information is assigned.

FIG. 28 is a diagram showing a quantum cipher writing device, a reading device, and a quantum cipher recording medium in accordance with a seventh exemplary embodiment of the present invention.

FIG. 29 is a diagram showing a quantum cipher writing device, a reading device, and a quantum cipher recording medium in accordance with an eighth exemplary embodiment of the present invention.

FIG. 30 is a diagram showing a relation between phases of the quantum ensemble state and measured values.

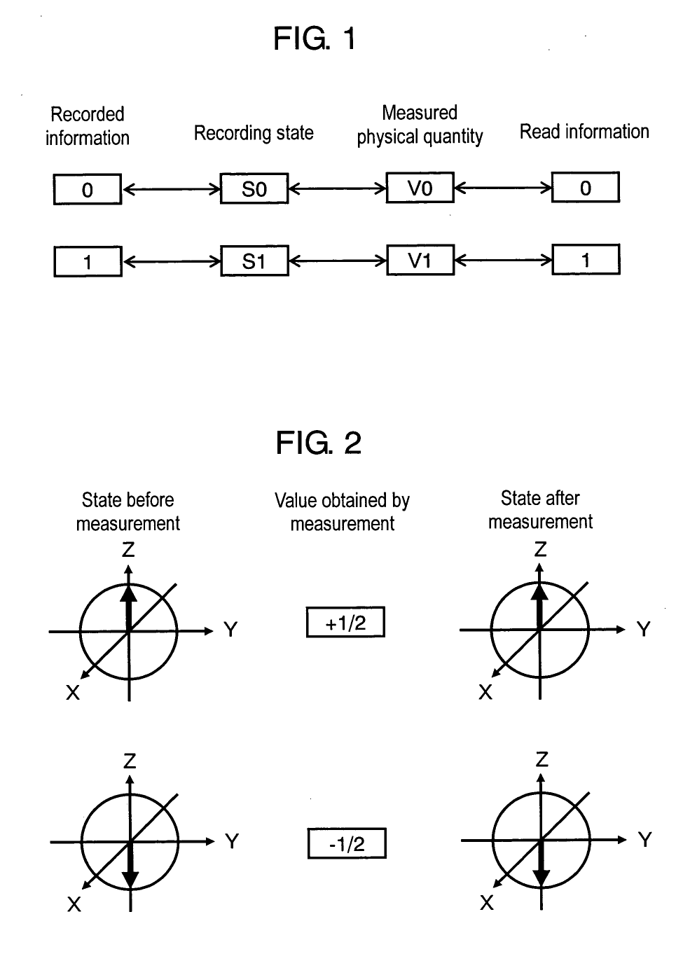

### DETAILED DESCRIPTION OF THE INVENTION

The recording method of the present invention requires a quantum cipher recording medium for storing a quantum state, a quantum cipher writing device for creating a specific quantum state in the quantum cipher recording medium, and a quantum cipher reading device for measuring the quantum state in the quantum cipher recording medium. Respective methods according to claim 1 and claim 4 further require a quantum cipher decrypting device for unitary-transforming the quantum state.

Various quantum states are considered to be used in the quantum cipher recording medium, but the methods according to claims 1 to 6 using spin are described as first to third exemplary embodiments and sixth to eighth exemplary embodiments. The methods according to claim 1 and claim 3 using a coupled quantum dot are described as fourth and fifth exemplary embodiments.

General properties of the quantum state are firstly described, taking spin as an example. Then, a fundamental element of a device required for each exemplary embodiment, and an information recording method using the device are described sequentially.

(General Properties of Quantum State)

(Property 1: Eigen-State)

“Spin” means an intrinsic angular momentum of a particle such as an electron, a photon, a proton, or a nucleus. The value of the spin depends on the particle type, and is always integer times or half-integer times larger than h/2π as a fundamental unit, where h is Planck constant. The spin can spatially points to an arbitrary direction, but measurement of the component of the spin in a certain direction always results in only integer times or half-integer times larger than the fundamental unit. For the sake of simplicity, the description is limited to a ½-spin system of electrons or the like.

In the ½-spin system, the measurement of the spin component in an arbitrary direction always results in only one of +½ and −½. The measurement result depends on the direction of the spin just before the measurement. In the measurement of the component in the Z-direction, as shown in FIG. 2, the measurement result is always +½ when the spin points to the positive Z-axis direction just before the measurement, or always −½ when the spin points to the negative Z-axis direction just before the measurement.

The quantum state that always provides the same measurement result is called an eigen-state. When the system lies in the eigen-state, the state can remain constant even after repeating of the same measurement, and the same measurement result is always obtained.

(Superposition State)

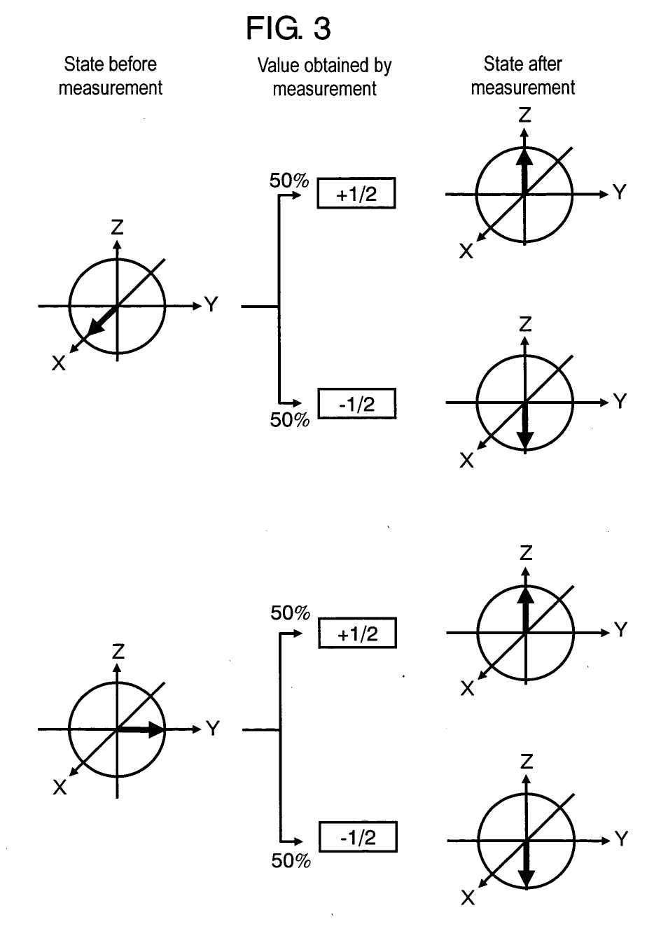

When the spin points to a direction other than the positive Z-axis direction and the negative Z-axis direction, as shown in FIG. 3, the measurement result of the component in the Z-axis direction is not constant. The variation of the measurement result is essential, and cannot be removed no matter how the measuring device is improved. When the spin points to a direction parallel with the X-axis or Y-axis, the measurement result of the component in the Z-axis direction is +½ or −½ at 50% probability.

A state having a probabilistic measurement result is called a superposition state. The superposition state is peculiar to the quantum state, and does not correspond to classical states.

(Irreversibility)

The quantum state changes at the instant when measurement is performed. Even when the spin originally points to the direction parallel with the X axis, for example, the spin points to the positive Z-axis direction when the measurement result of the Z-component is +½, or the spin points to the negative Z-axis direction when the measurement result is −½. When a system in a superposition state is measured, the system changes to one of the eigen-states probabilistically. The state after the change can be known based on the obtained measurement result, but the direction before the measurement cannot be known. This change is irreversible, and hence the system after the measurement cannot be returned to the state before the measurement or re-measured by any operation.

(Unidentifiability)

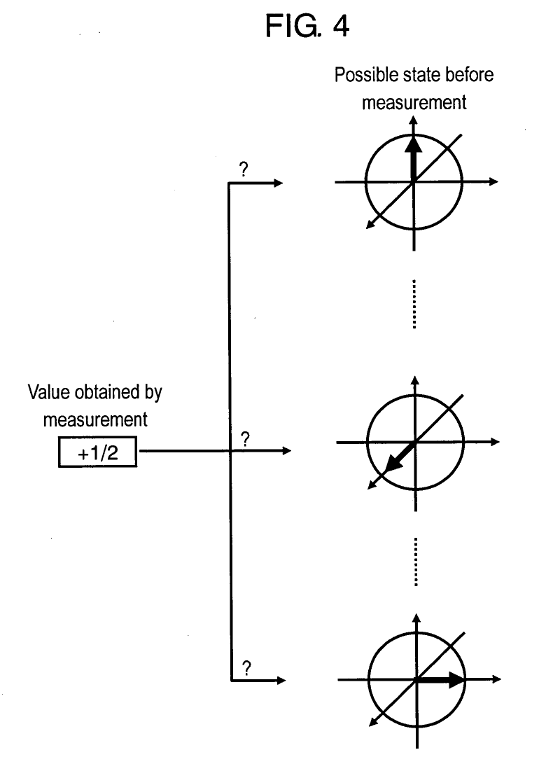

According to quantum mechanics, there is no method of perfectly acquiring a present state of the system. For example, which direction the spin points to cannot be known perfectly. Only determination of physical quantity by measurement is available. The measurement shows only whether the system just before the measurement lies in the eigen-state corresponding to the measurement result or in a superposition state including the eigen-state. For example, the state of the spin can be acquired by measuring the Z-component as the physical quantity. As shown in FIG. 4, however, even when measurement result of +½ is obtained, this result shows only that the spin does not point to the negative Z-axis direction. It cannot be distinguished between two following conditions:
the spin originally points to the positive Z-axis direction and measurement result of +½ is obtained inevitably; and
the spin originally points to the positive X-axis direction or the positive Y-axis direction and measurement result of +½ is obtained accidentally.

(No-Cloning Nature)

An unknown quantum state cannot be copied. Regarding spin, when the direction of the spin cannot be acquired, the unknown direction cannot be copied. This is called no-cloning nature, and this property is guaranteed by the principle of quantum mechanics. Only the eigen-state of which physical quantity is determined by measurement can be copied. In other words, at the moment when a certain physical quantity is determined by measurement, the system is guaranteed to lie in the eigen-state corresponding to the physical quantity, and the state can be copied. Regarding the spin, after a certain directional component of the spin is determined and the spin is put into an eigen-state, many same states can be created in response to the measured value. In this method, when the system is guaranteed to originally lie in an eigen-state, perfect copy can be produced. When the system lies in a superposition state, however, the copy of this original state is not made. In other words, the system is changed into an eigen-state by measurement and the eigen-state is copied, but this eigen-state is different from the original superposition state.

When it is not known whether the original state is an eigen-state or a superposition state, the following result is obtained. The copy succeeds when the system lies in the eigen-state accidentally, but the copy fails when the system lies in the superposition state. When there are many objects to be copied and a sufficient percent of the objects lie in superposition states, possibility of perfect success in copy is extremely small.

Regarding the spin, when only states parallel with a measured direction are guaranteed to exist, perfect copy can be made. When nonparallel states can be mixed, the perfect copy cannot be made.

(Incompatible Physical Quantities)

When a certain physical quantity is measured, information of another physical quantity is damaged. For example, the component in an arbitrary direction of the spin can be measured. When the component in a certain direction is measured, however, all information related to the component orthogonal to the certain direction is lost. When the spin points to the positive X-axis direction just before measurement, for example, selecting the X-axis direction as the measurement direction inevitably provides measurement result +½. However, selecting the Z-axis direction as the measurement direction provides measurement result +½ or −½ at 50% probability. Once the measurement in the Z-axis direction is performed, measurement in the X-axis direction also results in +½ or −½ at 50% probability. In other words, information that the spin originally points to the positive X-axis direction is completely lost.

Such physical quantities having a relation where measuring one physical quantity damages the information of the other physical quantity are called incompatible physical quantities. As physical quantities having such a relation, nonparallel spin components, position and momentum, the number of photons and phase of light, and the number of Cooper electron pairs and order parameter in super-conduction are known.

(Retainability)

The quantum state generally changes over time. The change over time depends on the kind of the quantum state, the structure of the system having the quantum state, and the electrical field and magnetic field interacting with the system. When a specific condition is fulfilled, the quantum state can remain constant over time. When a spin does not interact with an external condition, the direction can be retained regardless of whether the spin lies in an eigen-state or in a superposition state. Here, the external condition is a magnetic field, an electromagnetic wave, or heat, for example.

(Unitary Transformation)

The quantum state can be changed reversibly. When a static magnetic field is applied to a spin, the spin rotates at a constant angular velocity on a plane vertical to the magnetic field. This is called precession. The angular velocity is kept constant by fixing applied magnetic field strength, and the rotation is stopped by stopping the application of the magnetic field. When the magnetic field is applied to the spin with strength, direction, and time controlled, the spin can be rotated by an expected angle. It is important that this rotation changes only the relative angle from the initial position. In other words, when the spin originally points to the positive Z-axis direction, the direction of the spin does not change after 90° rotation about the Z-axis. When the spin originally points to the positive Y-axis direction, the spin points to the positive X-axis direction after 90° rotation about the Z-axis. Even when the rotation is performed from a state where the original direction of the spin is not known, the direction cannot be specified either. However, the spin rotation is different from the change by measurement, and is reversible before the measurement. When the spin is rotated from a certain direction by a certain angle, the spin is returned to the original direction by rotating the spin by the reverse angle of the rotation performed before the measurement. Such reversible state transformation is generally called unitary transformation.

### First Embodiment

(Fundamental Elements of Recording Device for Performing First Embodiment)

Performing of the method according to claim 1 of the present invention requires the following elements:
a quantum cipher writing device for creating a specific quantum state in response to information to be recorded and information called a reading key;
a quantum cipher recording medium for storing the quantum state;
a decrypting device for applying unitary transformation to the quantum cipher recording medium in response to the reading key information; and
a quantum cipher reading device for finally measuring the quantum state.
   The first embodiment is described using a spin as the quantum state of claim 1 of the present invention.

When the spin is used as the quantum state, the initialization corresponds to turning the spin to a specific direction, and the unitary transformation corresponds to the rotation of the spin.

These devices can be formed in various methods. A method of using a nuclear spin of an ion caught in a magnetic field in ultra-high vacuum is considered, for example, but the devices are required to be large and hence it is practically inconvenient. A method of using an extra electron in a quantum dot is described hereinafter. Here, the quantum cipher writing device, the quantum cipher recording medium, the decrypting device, and the quantum cipher reading device are all integrated. Each device and the medium may be separable.

(Devices for First Embodiment)

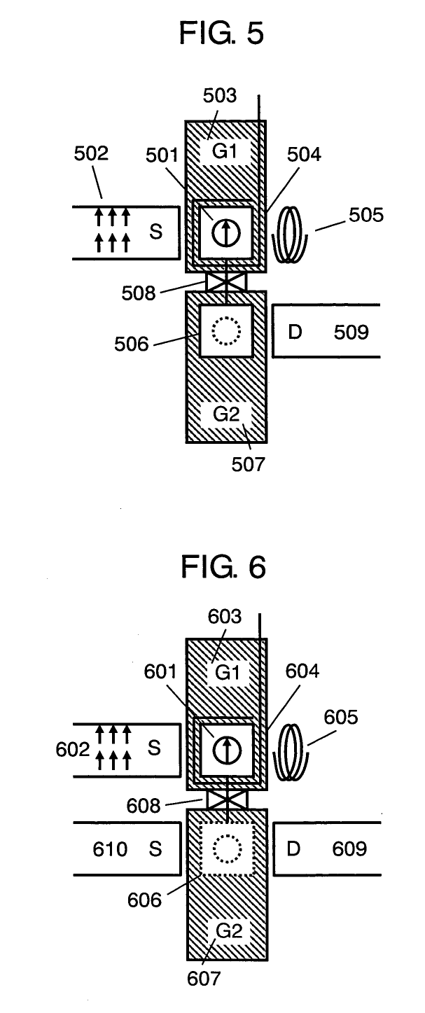

A configuration of the quantum cipher recording device in accordance with the first exemplary embodiment is shown in FIG. 5. The recording device includes the following elements:
recording quantum dot 501 for holding the spin of the extra electron:
ferromagnetic body source 502 for supplying a spin-polarized electron to the recording quantum dot;
first gate electrode 503 for varying the potential of the recording quantum dot;
first spin rotating coil 504 for applying a vertical magnetic field to the extra electron:
second spin rotating coil 505 for applying a horizontal magnetic field to the extra electron:
reading quantum dot 506 for measuring the spin of the extra electron:
second gate electrode 507 for varying the potential of the reading quantum dot;
spin valve 508 for passing only the spin-polarized electron from the recording quantum dot to the reading quantum dot in the positive direction with respect to the measurement direction; and
drain electrode 509 for extracting the extra electron from the reading quantum dot.
   This is a fundamental configuration unit for recording 1 bit of information. For holding 1 or more bits of information, a required number of fundamental configuration units are prepared. All the elements can be integrated on a board such as a normal semiconductor memory.

Additionally, the recording device has a control circuit (not shown) for controlling potentials of the electrodes and coil current in response to input information and an output circuit (not shown) for outputting signal 0 or 1 in response to difference in current flowing from the drain electrode. Low temperature is advantageous for keeping the direction of the spin for a long time, so that a cooling device may be added to the fundamental configuration. Interaction with an electromagnetic field also can cause a recording error, so that the memory may be covered with a shield for cutting off the electromagnetic field. The shield may be made of a conductor such as metal or photonic crystal.

This configuration allows the following operations:
turning the spin to the specific direction in response to the information to be recorded and information called the reading key;
holding the direction;
rotating the spin in response to the reading key information; and finally
reading the spin component in the specific direction.

(Fundamental Function of Each Element)

(Quantum Dot)

“Quantum dot” means a configuration capable of containing a charge such as an electron or positive hole in a micro region of nanometer size.

As an example of the quantum dot, a configuration where a semiconductor such as Si or GaAs is surrounded by an insulator such as SiO₂ can be used. This configuration can be produced using a semiconductor processing technology such as dry etching or epitaxial growth. As another example, a configuration where two defects are formed in a conductive carbon nanotube is used. The region between two defects shows property as the quantum dot. The defects in the carbon nanotube can be formed by a physical operation with an atomic force microscope (AFM) or a treatment by ion irradiation.

The quantum dot is formed of a solid body and hence actually includes many electrons. When only one extra electron is contained in the quantum dot held in an electrically and magnetically neutral state, however, the extra electron can be treated as a particle of spin ½. When interaction with an external condition such as a magnetic field or an electromagnetic wave is prevented while only one extra electron is contained in the quantum dot, the direction of the spin can be kept using the extra electron in the quantum dot.

The device for the first embodiment uses the recording quantum dot that contains the extra electron and holds the spin and the reading quantum dot that reads the spin information of the recording quantum dot.

(Initialization and Writing of Quantum Dot)

Source 502 and first gate electrode 503 are used for generating a state where only one extra electron exists in recording quantum dot 501.

First gate electrode 503 is disposed near recording quantum dot 501 through an insulating layer. The insulator between first gate electrode 503 and recording quantum dot 501 has a sufficient thickness or a sufficient barrier height and prevents electrons from moving between the electrode and the dot. Since first gate electrode 503 is disposed near recording quantum dot 501, the potential of recording quantum dot 501 can be changed by changing the potential of first gate electrode 503.

Source 502 is made of a conductor and is connected to the power supply, so that the source can be used as an electron supply source. Source 502 is disposed near recording quantum dot 501 through a thin insulator.

The potential of source 502 can be also controlled. Since the insulator for separating source 502 and recording quantum dot 501 from each other is thin, electrons can move between them due to a tunneling phenomenon. The tunneling phenomenon is set to be controllable by a Coulomb brocade phenomenon discussed later.

Electrons can be accumulated in recording quantum dot 501. Electrons have a charge and repel each other by virtue of the Coulomb interaction, so that the quantum dot has energy increasing with increase in the number of electrons in the quantum dot. For adding an electron into the quantum dot, energy for compensating the energy increase due to the change of the number of electrons must be generated in a form of the potential difference between source 502 and the quantum dot. When this condition is not satisfied, the number of electrons is not changed, namely the tunneling does not occur. This is the Coulomb brockade phenomenon.

The Coulomb interaction increases with decrease in dot size, so that potential difference for changing the number of electrons can be increased to a level controllable by a normal semiconductor circuit. When the potential of source 502 and the potential of recording quantum dot 501 are controlled through first gate electrode 503 using the above-mentioned phenomenon, only one extra electron is exactly put into recording quantum dot 501. The Coulomb brocade phenomenon is used as a fundamental operation principle of a single electron transistor, and a potential condition or the like for controlling this phenomenon is described in detail in a reference (“Introduction to single electron tunneling” by Junshi Haruyama, Corona Publishing Co., Ltd)

(Spin Injection)

A spin in the quantum dot must be turned to a specific direction in response to the information to be recorded and the reading key in the present invention. For turning the spin to the specific direction, the spin is temporarily turned to a certain direction, and is then rotated by a desired angle. A means for cooling the spin to a cryogenic temperature with a magnetic field applied to the spin is generally employed for turning the spin to the specific direction. The cryogenic temperature state is generated for putting the spin into the lowest energy state, because the energy of the spin is the lowest when the spin is parallel with the magnetic field. However, this method requires a device for cooling temperature to the cryogenic temperature and a magnetic field applying device, and hence the whole device must be large. A passage through which the energy of the spin travels to the outside is required for putting the spin into the lowest energy state by cooling, but this passage damages a normal recording state. Therefore, the system that can be initialized by cooling is disadvantageous for keeping the recording for a long time.

The present embodiment therefore employs a method using ferromagnetic body source 502. In the ferromagnetic body, spins can be aligned in a specific direction by so-called magnetization even at room temperature. When the ferromagnetic body is used as an electron supply source to the quantum dot, an electron pointing to the specific direction can be injected. For keeping the direction of the spin in the injection, impurities having magnetism are prevented from existing in the insulating film, and an undesired external magnetic field is prevented from being applied.

(Unitary Transformation)

The direction of the spin of the extra electron injected into recording quantum dot 501 is the same as that of the magnetization of source 502 as it is. The direction of the spin must be varied in response to a value to be recorded after the injection. When the magnetic field is applied to the spin with strength, direction, and time controlled, the spin can be turned to a specific direction using precession, as discussed above. The magnetic field applied to the quantum dot can be arbitrarily generated by disposing a coil near recording quantum dot 501 and by controlling the position of the coil, the current flowing through it, and the time. In this embodiment, first spin rotating coil 504 and second spin rotating coil 505 correspond to that coil. First spin rotating coil 504 generates a vertical magnetic field, and second spin rotating coil 505 generates a horizontal magnetic field to the extra electron. When magnetic fields in two different directions are set independently controllable, a magnetic field in an arbitrary direction can be generated and the spin can be turned to an arbitrary direction.

(Read of Spin)

A reading method of the component in the spin direction of the extra electron in the quantum dot is finally described. This can be performed using reading quantum dot 506 and a spin valve.

Reading quantum dot 506 is initially set to be electrically and magnetically neutral. In other words, the number of extra electrons is 0, and there is no spin. Reading quantum dot 506 has second gate electrode 507 for controlling the potential similarly to recording quantum dot 501, and can control the potential.

Recording quantum dot 501 is connected to reading quantum dot 506 via an insulator or a semiconductor. An extra electron can be moved from recording quantum dot 501 to reading quantum dot 506 only when a potential difference for generating electron tunneling through the insulator is produced, by controlling the potential of recording quantum dot 501 with first gate electrode 503 and controlling the potential of reading quantum dot 506 with second gate electrode 507.

A mechanism that is called a spin valve or a spin filter, passes only an electron having a spin in a specific direction, and reflects a spin in the opposite direction is disposed between two quantum dots (recording quantum dot 501 and reading quantum dot 506). The spin valve is described in detail in patent document (Japanese Patent Unexamined Publications No. 2003-152173).

An example using the spin valve for passing only an electron having a spin in the positive Z-axis direction is described hereinafter. When the spin of the extra electron that is contained in a quantum dot for recording and retaining points to the positive Z-axis direction, the electron can be carried to reading quantum dot 506 at 100% probability. When the spin points to the negative Z-axis direction, the electron can be carried at 0% probability. When the spin points to the direction other than these directions, the electron can be carried at intermediate probability between 0 and 100% in response to the direction.

Whether or not the extra electron has been carried to reading quantum dot 506 is determined by detecting the current flowing through a drain electrode. The drain electrode is disposed near reading quantum dot 506 through an insulator. The electron transfer from reading quantum dot 506 to the drain electrode is just reverse to the electron transfer from source 502 to recording quantum dot 501. When the potential of reading quantum dot 506 controlled by second gate electrode 507 and the potential difference of the drain electrode are sufficiently applied, the electron tunnels from reading quantum dot 506 to drain electrode 509 to make drain current flow. When this current is amplified by an amplifier formed of a typical semiconductor circuit and the current value is confirmed, it can be determined whether or not the extra electron exists in reading quantum dot 506.

In other words, when drain current coupling to reading quantum dot 506 is detected, it can be detected that an electron exists in reading quantum dot 506 and further the original direction of the spin of recording quantum dot 501 is the positive Z-axis direction. In this configuration, the information of the spin direction of recording quantum dot 501 is transformed to information of the number of extra electrons in reading quantum dot 506, and can be detected based on the size of the drain current.

In this method, the original current flowing into the drain is extremely fine, so that the detection can be difficult. In this case, as shown in FIG. 6, a field-effect transistor using reading quantum dot 506 as the gate electrode may be formed, and the existence of an extra electron in reading quantum dot 506 may be detected based on the drain current flowing from source 502. In this configuration, in response to the presence or absence of the extra electron in reading quantum dot 506, the potential of the gate electrode varies, the conductivity of the channel varies, and hence the drain current varies. Thus, the presence or absence of the extra electron in reading quantum dot 506 can be determined based on the drain current. In this configuration, the extra electron is not discharged from reading quantum dot 506 even when the drain current measurement for determining the presence or absence of the extra electron is performed, so that stable measurement is allowed.

All the spin control discussed above can be electrically performed with a typical transistor. The whole electron transfer from source 502 to recording quantum dot 501 and reading quantum dot 506, and finally to the drain is allowed by controlling respective potentials. This can be performed by a control circuit formed of a typical semiconductor. The current flowing through a rotating coil for rotating the spin can be controlled similarly. Finally, the drain current corresponding to the reading result of the information can be detected by the typical semiconductor circuit. In other words, all processes of turning the spin to a specific direction, rotating the spin, and finally reading it can be electrically controlled with the typical semiconductor circuit.

The first exemplary embodiment requires the following elements:
a device for turning the spin to the specific direction in response to information to be recorded and information called a reading key;
a quantum recording medium for holding the spin;
a device for rotating the spin in response to the reading key information; and
a device for reading the spin component in the specific direction. Even when the processes are performed by a method other than the method discussed above, naturally, this does not affect the present invention.

One device can perform all of recording, holding, decryption, and reproduction in the example discussed above; however, the information holding part may be separated from the writing device, the decrypting device, and the reading device.

(Recording/Reproducing Method of First Embodiment)

Recording and reproducing procedures of information using the quantum cipher recording medium, the quantum cipher writing device, the quantum cipher decrypting device, and the quantum cipher reading device are described hereinafter.

(Recording)

An information recording person firstly prepares information to be recorded. It is preferable to previously mathematically encrypt the information to be recorded because the mathematical encryption largely increases the safety of the information as described later. However, the mathematical encryption is not absolutely necessary.

It is assumed here that the information to be recorded is information derived by describing the text in “ ” of “This is a pen.” (this is taken in a conventional technology) with ASCII code and by encrypting the text with key “KEY”. The information is represented as

| | | |
|---|---|---|
| 0011111 | 0101101 | 0110000 |
| 0111000 | 1100101 | 0110000 |
| 0111000 | 1100101 | 0111000 |
| 1101011 | 0110101 | 0111100 |
| 0100101 | 1101011 | 1111001. |

The information recording person prepares information called a reading key and an algorithm for determining a base used for recording based on the reading key, besides the information to be recorded. The reading key requires the following conditions:
a person who knows the reading key can specify the base used for recording each bit; and
a person who does not know the reading key cannot specify the base even when he/she knows the algorithm.
   The safety of the information is not guaranteed when the information about the reading key leaks. Therefore, information that unauthorized information user cannot easily estimate is prepared. It is assumed to prepare reading key “PHY”.

The information recording person determines a base to be used for recording each bit according to the prepared algorithm. The determination can be performed as follows. The binary notation with ASCII code of the reading key is represented as

| | | |
|---|---|---|
| 1010000 | 1001000 | 10110001. |

The information to be recorded has 105 bits and the ASCII binary notation of the reading key has 21 bits, so that the binary notation must be extended. A simplest method, namely a method of repeating the reading key until the length of the information to be recorded is the same as that of the reading key is employed. It is preferable that a method other than this key extending method having high periodicity is used, similarly to the mathematical encryption. However, this key extending method does not affect an essential part of the present invention. The key extending method is therefore described. A bit string with a length equal to that of the information to be recorded is prepared. A base used for each bit can be determined in a method where base A is used when the bit value is 0 or base B is used when the bit value is 1. A base used for each bit may be determined in an algorithm other than the algorithm discussed above. Here, the following conditions must be satisfied:
a person who does not know the reading key cannot determine the base used for each bit; and
a person who knows the reading key can uniquely determine the base used each bit.

Generally, a base determining algorithm is previously built in the quantum cipher writing device, and the base of each bit is automatically determined when the reading key is input. In this case, the recording person inputs information to be recorded and a reading key into a control unit of the quantum cipher writing device. It is assumed in all embodiments that the base determining algorithm is built in the quantum cipher writing device. As a matter of course, the building-in of the algorithm is not absolutely necessary. The recording person may determine the base from the reading key with another computer, or manually in some cases, and may input it into the quantum cipher writing device.

The control unit of the quantum cipher writing device selects a quantum state to be created in each recording quantum bit based on the above-mentioned information. The quantum state is selected so as to satisfy the following conditions:
a measured value corresponding to the recorded information is obtained when a correct decryption corresponding to each base is performed and the measurement is then performed; and
the correct decryption cannot be performed when the base of each bit cannot be specified, and the recorded information cannot be obtained from the measurement result when the measurement is performed without correct decryption.

This selection can be realized by assuming the following conditions:
state A0 is set when information to be recorded is 0 and the base specified by the reading key is A;

state A1 is set when information to be recorded is 1 and the base specified by the reading key is A;

state B0 is set when information to be recorded is 0 and the base specified by the reading key is B; and

state B1 is set when information to be recorded is 1 and the base specified by the reading key is B, and by selecting states A0 to B1 as follows.

Specific contents of the four quantum states are determined by selecting two decrypting procedures UA and UB and two eigen-states S0 and S1.

Eigen-states S0 and S1 may be two eigen-states distinguishable by measurement. In the present embodiment, S0 and S1 indicate a state where the spin points to the positive Z-axis direction and a state where the spin points to the negative Z-axis direction, respectively.

Decrypting procedures UA and UB are two different unitary transformations. These unitary transformations are selected so as to satisfy two following conditions.

Condition 1: The unitary transformations are different from each other.

Condition 2: The unitary transformations are reversible, so that inverse transformations exist certainly. The inverse transformations of UA and UB are denoted as UA−1 and UB−1. Regarding spin, inverse rotation corresponds to the inverse transformations. Using S0, S1, UA−1 and UB−1, four quantum states used for recording are determined as
A0=UA⁻¹S0
A1=UA⁻¹S1
B0=UB⁻¹S0
B1=UB⁻¹S1.
   At least one superposition state is included in four following quantum states defined from the quantum states A0, A1, B0 and B1:

a state derived by unitary-transforming (UB) quantum state A0;

a state derived by unitary transforming (UB) quantum state A1;

a state derived by unitary transforming (UA) quantum state B0; and

a state derived by unitary-transforming (UA) quantum state B1.

Ideally, all of four quantum states are superposition states. For example, when non-rotation is selected as UA and 90° rotation about the Y-axis is selected as UB, A0 is the state where the spin points to the positive Z-axis direction, A1 is the state where the spin points to the negative Z-axis direction, B0 is the state where the spin points to the positive X-axis direction, and B1 is the state where the spin points to the negative X-axis direction.

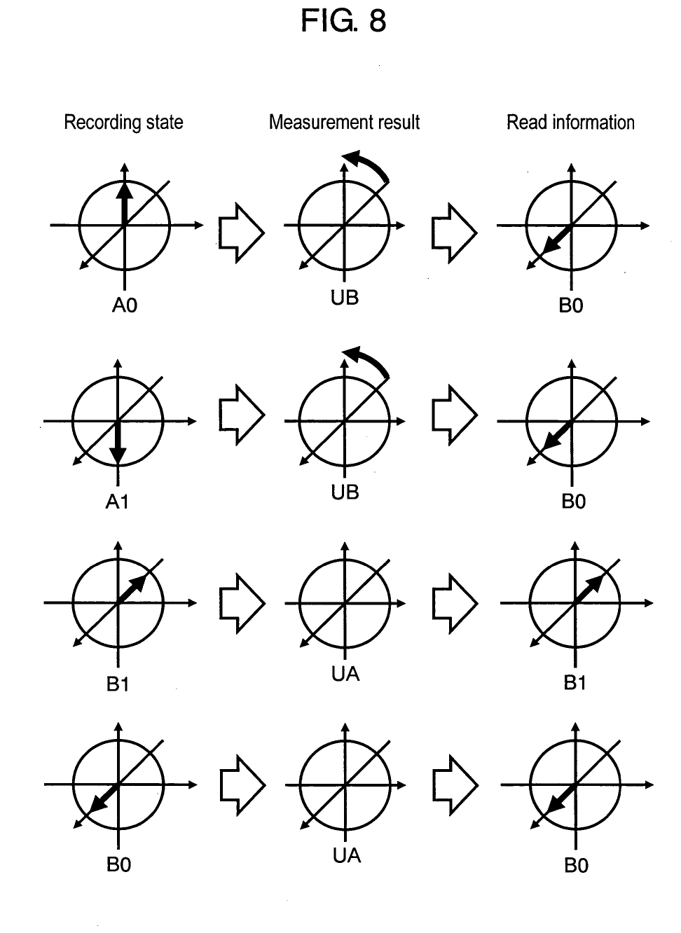

As shown in FIG. 8, when unitary transformation UB is applied to A0 and A1 or unitary transformation UA is applied to B0 and B1, resultant states are B0 and B1. These are superposition states and hence satisfy Conditions 1 and 2.

Recording in A0 and A1 is called recording with base A, and recording in B0 and B1 is called recording with base B.

The quantum states specified from the information to be recorded and the reading key are represented by

| | | |
|---|---|---|
| B0, A0, B1, A1, A1, A1, A1 | B0, A1, A0, B1, A1, A0, A1 | B0, A1, B1, B0, A0, A0, B0 |
| B0, A1, B1, A1, A0, A0, A0 | B1, A1, A0, B0, A1, A0, A1 | B0, A1, B1, B0, A0, A0, B0 |
| B0, A1, B1, A1, A0, A0, A0 | B1, A1, A0, B0, A1, A0, A1 | B0, A1, B1, B1, A0, A0, B0 |
| B1, A1, B0, A1, A0, A1, A1 | B0, A1, A1, B0, A1, A0, A1 | B0, A1, B1, B1, A1, A0, B0 |
| B0, A1, B0, A0, A1, A0, A1 | B1, A1, A0, B1, A0, A1, A1 | B1, A1, B1, B1, A0, A0, B1. |

(Write)

The selected quantum states is created in each information recording part of the quantum recording medium using the quantum cipher writing device. In the present embodiment, the control unit controls the electrode voltage and coil current, and creates a quantum state to be recorded in each recording quantum dot 501. In other words, by controlling voltages of source 502 and first gate electrode 503, only one extra electron is injected into each recording quantum dot 501. By controlling currents of first and second spin rotating coils and controlling a magnetic field applied to each quantum dot in response to a state to be creased in each recording quantum dot 501, the spin in recording quantum dot 501 is turned to the direction specified above (positive Z-axis direction in A0, negative Z-axis direction in A1, positive X-axis direction in B0, and negative X-axis direction in B1).

(Retention)

The quantum state formed in the quantum cipher recording medium is retained until decryption. In the present embodiment, the direction of the spin of the extra electron injected into each recording quantum dot 501 is retained until decryption. For retention, an undesired external magnetic field and electromagnetic wave are prevented from being applied to each recording quantum dot 501.

Here, the information recording person delivers, to an authorized information user, the quantum cipher recording medium, the information of a reading key, the algorithm used for specifying the base of each bit based on the reading key, the key used for decrypting the mathematical cipher, and the algorithm used for decrypting the mathematical cipher. The algorithm used for specifying the base based on the reading key and the algorithm used for decrypting the mathematical cipher may be publicly known, on condition that the reading key and the key of the mathematical cipher are required for specifying the base and decrypting the mathematical cipher. It is assumed that the quantum cipher recording medium can be delivered to the unauthorized information user, similarly to a typical recording method. The reading key and the key used for decrypting the mathematical cipher are known only by the authorized information user.

(Decryption)

The authorized information user applies a decryption operation to the received quantum cipher recording medium with the quantum cipher decrypting device. The decryption operation is unitary transformation for changing all quantum states storing the information to eigen-states.

Spins are used as the quantum states in the present embodiment, so that all the spins are turned to the direction parallel with the Z-axis in the decryption operation.

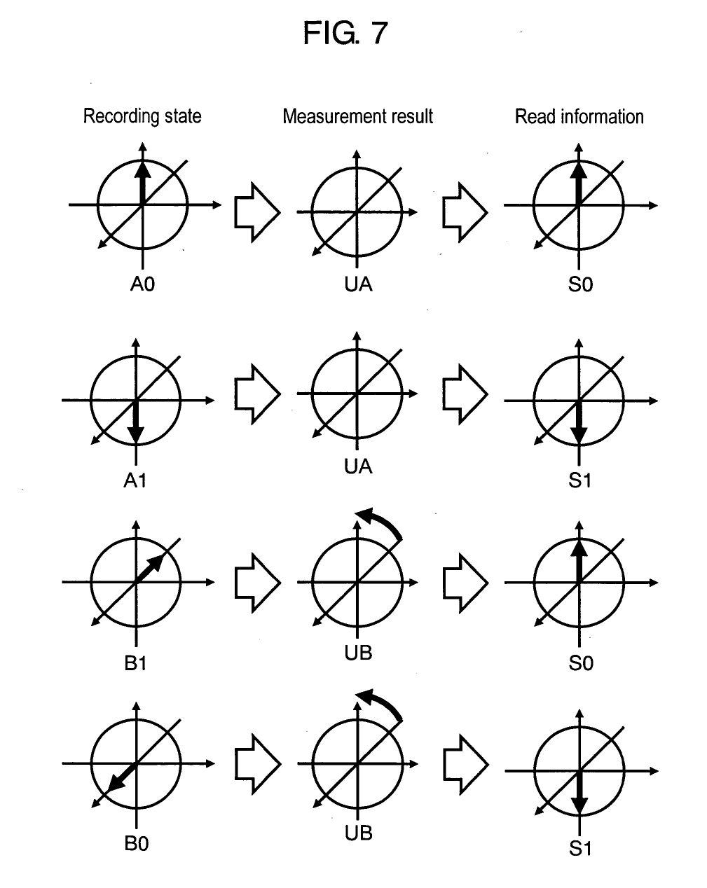

The quantum states used for recording are four states,
A0=UA⁻¹S0
A1=UA⁻¹S1
B0=UB⁻¹S0
B1=UB⁻¹S1.
   Therefore, when unitary transformation UA is applied to A0 and A1 or unitary transformation UB is applied to B0 and B1,
UA A0=UA UA⁻¹ S0=S0
UA A1=UA UA⁻¹ S1=S1
UB B0=UB UB⁻¹ S0=S0
UB B1=UB UB⁻¹ S1=S1
   is obtained, thereby transforming A0, A1, B0 and B1 to respective eigen-states. This decryption is shown in FIG. 7. In other words, A0 and A1 are decrypted by transformation UA, and B0 and B1 are decrypted by transformation UB. In the decryption operation of the present embodiment, UA is non-rotation and UB is 90° rotation about the Y-axis. This decryption operation can be performed by controlling the current flowing through first and second spin rotating coils in the device of the present embodiment.

As discussed above, the reading key as information used for specifying the base is delivered to the authorized information user. The authorized information user can thus specify the decryption to be applied to each recording quantum dot 501.

In the present embodiment, the decryption operation that is specified by the correct reading key and algorithm and is applied to each recording quantum dot 501 is represented as

| | | |
|---|---|---|
| UB, UA, UB, UA, UA, UA, UA | UB, UA, UA, UB, UA, UA, UA | UB, UA, UB, UB, UA, UA, UB |
| UB, UA, UB, UA, UA, UA, UA | UB, UA, UA, UB, UA, UA, UA | UB, UA, UB, UB, UA, UA, UB |
| UB, UA, UB, UA, UA, UA, UA | UB, UA, UA, UB, UA, UA, UA | UB, UA, UB, UB, UA, UA, UB |
| UB, UA, UB, UA, UA, UA, UA | UB, UA, UA, UB, UA, UA, UA | UB, UA, UB, UB, UA, UA, UB |
| UB, UA, UB, UA, UA, UA, UA | UB, UA, UA, UB, UA, UA, UA | UB, UA, UB, UB, UA, UA, UB |

Generally, the algorithm used for determining the decryption operation from the reading key is previously built in a control unit of the quantum cipher decrypting device. A corresponding decryption is thus automatically started only by inputting the reading key and a command for decryption into the control unit.

Each recording quantum dot 501 after the decryption operation lies in the state represented by

| | | |
|---|---|---|
| S0, S0, S1, S1, S1, S1, S1 | S0, S1, S0, S1, S1, S0, S1 | S0, S1, S1, S0, S0, S0, S0 |
| S0, S1, S1, S1, S0, S0, S0 | S1, S1, S0, S0, S1, S0, S1 | S0, S1, S1, S0, S0, S0, S0 |
| S0, S1, S1, S1, S0, S0, S0 | S1, S1, S0, S0, S1, S0, S1 | S0, S1, S1, S1, S0, S0, S0 |
| S1, S1, S0, S1, S0, S1, S1 | S0, S1, S1, S0, S1, S0, S1 | S0, S1, S1, S1, S1, S0, S0 |
| S0, S1, S0, S0, S1, S0, S1 | S1, S1, S0, S1, S0, S1, S1 | S1, S1, S1, S1, S0, S0, S1. |

The states in all recording quantum dots 501 are eigen-states. At this time, the extra electron is retained in each recording quantum dot 501. The directions of all spins are parallel with the Z-axis.

(Read)

After the system can be transformed into the eigen-state, the quantum cipher recording medium is measured by the quantum cipher recording device. The measurement can be performed using reading quantum dot 506 and the drain in the present embodiment, as discussed above. Specifically, when a command signal of reading is input into a control unit, the control unit carries the electron from recording quantum dot 501 to reading quantum dot 506 through the spin valve. After the completion of the carrying, it is detected using the drain current whether or not an extra electron exists in reading quantum dot 506, and it is determined based on the drain current whether or not the extra electron exists in reading quantum dot 506. The magnitude of the drain current corresponds to the Z-component of the spin of the extra electron originally existing in recording quantum dot 501, as discussed above. The difference in magnitude of the drain current is output with a circuit for outputting a signal corresponding to 0 or 1.

Since the decryption is previously performed, the states in all recording quantum dots 501 are eigen-states. When measurement is performed in this situation, a measurement result corresponding to each eigen-state

| | | |
|---|---|---|
| 0011111 | 0101101 | 0110000 |
| 0111000 | 1100101 | 0110000 |
| 0111000 | 1100101 | 0111000 |
| 1101011 | 0110101 | 0111100 |
| 0100101 | 1101011 | 1111001 |

is output.

This is the just recorded mathematically-encrypted information. Therefore, when the authorized information user decrypts this information using cipher key “KEY” of the mathematical cipher and interprets it according to the ASCII code table, the user can obtain the text in “ ” of “This is a pen.” that the recording person intends to send.

Thus, the quantum cipher recording device and recording method of the present invention allow the authorized information user to obtain correct information, similarly to the conventional recording method.

(Unauthorized Read)

The unauthorized decryption by an unauthorized information user is described hereinafter. As assumed above, the unauthorized information user can obtain a medium where information is recorded and knows the algorithm for specifying the base from the reading key and the algorithm for mathematical decryption, but does not know the reading key or the mathematical cipher key.

The processes until retention of information are the same as those of the authorized use of the information, so that the description of the processes is omitted.

Since the unauthorized information user does not know the reading key, the user cannot specify the base used for recording of each recording quantum dot and hence cannot specify a correct decryption to be performed. Similarly to the unauthorized decryption of the mathematical cipher, an unauthorized decryption method in which reading keys are tried in a round-robin manner is described. For example, “AAA” is firstly used as a reading key candidate.

The decrypting operation specified by the reading key candidate “AAA” is represented as

| | | |
|---|---|---|
| UB, UA, UA, UA, UA, UA, UB | UB, UA, UA, UA, UA, UA, UB | UB, UA, UA, UA, UA, UA, UB |
| UB, UA, UA, UA, UA, UA, UB | UB, UA, UA, UA, UA, UA, UB | UB, UA, UA, UA, UA, UA, UB |
| UB, UA, UA, UA, UA, UA, UB | UB, UA, UA, UA, UA, UA, UB | UB, UA, UA, UA, UA, UA, UB |
| UB, UA, UA, UA, UA, UA, UB | UB, UA, UA, UA, UA, UA, UB | UB, UA, UA, UA, UA, UA, UB |
| UB, UA, UA, UA, UA, UA, UB | UB, UA, UA, UA, UA, UA, UB | UB, UA, UA, UA, UA, UA, UB. |

However, this operation is not perfectly match with the authorized decrypting operation, and table

| | | |
|---|---|---|
| OOXOOOX | OOOXOOX | OOXXOOO |
| OOXOOOX | OOOXOOX | OOXXOOO |
| OOXOOOX | OOOXOOX | OOXXOOO |
| OOXOOOX | OOOXOOX | OOXXOOO |
| OOXOOOX | OOOXOOX | OOXXOOO |

is obtained. Here, O indicates match with the authorized operation and X indicates non-match.

When the control unit decrypts the recording quantum dots using this reading key candidate, the state of each recording quantum dot after the decryption is represented as

| | | |
|---|---|---|
| S0, S0, B0, S1, S1, S1, B0 | S0, S1, S0, B0, S1, S0, B0 | S0, S1, B0, B1, S0, S0, S0 |
| S0, S1, B0, S1, S0, S0, B1 | S1, S1, S0, B1, S1, S0, B0 | S0, S1, B0, B1, S0, S0, S0 |
| S0, S1, B0, S1, S0, S0, B1 | S1, S1, S0, B1, S1, S0, B0 | S0, S1, B0, B0, S0, S0, S0 |
| S1, S1, B1, S1, S0, S1, B0 | S0, S1, S1, B1, S1, S0, B0 | S0, S1, B0, B0, S1, S0, S0 |
| S0, S1, B1, S0, S1, S0, B0 | S1, S1, S0, B0, S0, S1, B0 | S1, S1, B0, B0, S0, S0, S1. |

Here, S0 and S1 are eigen-states, and B0 and B1 are superposition states. When the incorrect decrypting operation is performed, superposition states occur definitely. This situation occurs according to the selection condition of quantum states.

When the measurement is performed in this situation, a value 0 or 1 having no correlation to the original recorded information is obtained at 50% probability from the quantum dots having a superposition state.

When the control unit is commanded to read the recording quantum dots having this state, an example of the final output signal is represented as

| | | |
|---|---|---|
| 0001111 | 0101101 | 0100000 |
| 0111000 | 1101101 | 0100000 |
| 0111001 | 1101101 | 0111000 |
| 1111011 | 0110101 | 0111100 |
| 0110100 | 1100011 | 1100001. |

This is simply one example, because the superposition states are determined probabilistically.

This signal is different from the original cipher text. When parts matching with the original cipher text are shown by O and parts different from the text are shown by X,

| | | |
|---|---|---|
| OOXOOOO | OOOOOOO | OOXOOOO |
| OOOOOOO | OOOXOOO | OOXOOOO |
| OOOOOOX | OOOXOOO | OOOOOOO |
| OOXOOOO | OOOOOOO | OOOOOOO |
| OOXOOOX | OOOXOOO | OOXXOOO |

is obtained.

Even when the read information is decrypted using correct mathematical cipher key “KEY”, the binary notation of the decrypted information is represented as

| | | |
|---|---|---|
| 1110000 | 0101001 | 0101111 |
| 0100011 | 0001001 | 0101111 |
| 0100011 | 0001001 | 0100011 |
| 0000010 | 0100101 | 0100001 |
| 0100101 | 0001110 | 0001111, |

and does not match with the binary notation of the original plain text. Even when this decrypted information is interpreted according to the ASCII code,

pR#G#FGJCK

is obtained and is inevitably different from the original plain text.

When any mathematical operation is applied to the information read by an incorrect decrypting operation, the original recorded information cannot be reproduced. That is because reading after the incorrect decrypting operation probabilistically changes the recorded information to information irrelevant to the recorded information.

When the unauthorized information user fails to perform unauthorized decryption with all considered mathematical ciphers, the user can know that decryption by the reading key is false.

Then, the case where the unauthorized information user tries another reading key similarly to the unauthorized decryption of a typical mathematical cipher is considered. In the case of typical mathematical encryption, even when the decryption with a key candidate is failed, the original cipher text itself does not become lost. Therefore, another key candidate is simply required to be tried on the original cipher text. While, in the present invention, the decryption with the reading key candidate has been failed and hence the stage of the decryption must be performed again.

The unauthorized information user has decrypted and read the original information, so that the state before the decryption must be reproduced for performing the decryption again. The unauthorized information user knows the fact that the tried reading key is “AAA” and the measurement result by the key, so that the user can only try to reproduce the state before the decryption using them.

The unauthorized information user knows the tried reading key, so that the user can specify the decrypting operation that has been applied to each bit. Therefore, when the state before the measurement can be specified, the inverse transformation of the decrypting operation is applied to the state to reproduce the state before the decryption.

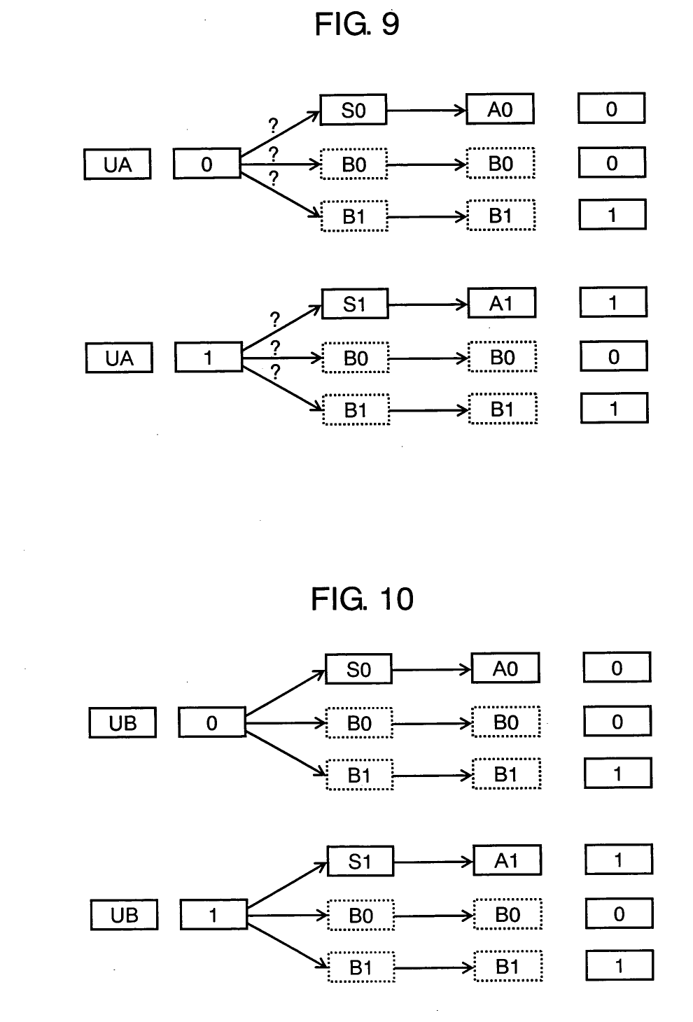

However, as shown in FIG. 9 and FIG. 10, when a certain reading result is obtained with a certain reading key, the number of states that can produce the reading result is always three for each bit. The quantum state cannot be identified, so that the unauthorized information user cannot specify how each recording state has been.

Correct information cannot be read from the other state producing the same reading result.

For example, it is assumed that all the states just before the reading are eigen-states,

| | | |
|---|---|---|
| S0, S0, S0, S1, S1, S1, S1 | S0, S1, S0, S1, S1, S0, S1 | S0, S1, S0, S0, S0, S0, S0 |
| S0, S1, S1, S1, S0, S0, S0 | S1, S1, S0, S1, S1, S0, S1 | S0, S1, S0, S0, S0, S0, S0 |
| S0, S1, S1, S1, S0, S0, S1 | S1, S1, S0, S1, S1, S0, S1 | S0, S1, S1, S1, S0, S0, S0 |
| S1, S1, S1, S1, S0, S1, S1 | S0, S1, S1, S0, S1, S0, S1 | S0, S1, S1, S1, S1, S0, S0 |
| S0, S1, S1, S0, S1, S0, S0 | S1, S1, S0, S0, S0, S1, S1 | S1, S1, S0, S0, S0, S0, S1. |

When the inverse transformation of the decryption corresponding to reading key “AAA” is applied to this state, the state in the recording quantum dot after the inverse transformation is represented as

| | | |
|---|---|---|
| B0, A0, A0, A1, A1, A1, B1 | B0, A1, A0, A1, A1, A0, B1 | B0, A1, A0, A0, A0, A0, B0 |
| B0, A1, A1, A1, A0, A0, B0 | B1, A1, A0, A1, A1, A0, B1 | B0, A1, A0, A0, A0, A0, B0 |
| B0, A1, A1, A1, A0, A0, B1 | B1, A1, A0, A1, A1, A0, B1 | B0, A1, A1, A1, A0, A0, B0 |
| B1, A1, A1, A1, A0, A1, B1 | B0, A1, A1, A0, A1, A0, B1 | B0, A1, A1, A1, A1, A0, B0 |
| B0, A1, A1, A0, A1, A0, B0 | B1, A1, A0, A0, A0, A1, B1 | B1, A1, A0, A0, A0, A0, B1, |

and is different from the originally recorded state.

Even when this state is decrypted using the original reading key “PHY”,

| | | |
|---|---|---|
| S0, S0, B1, S1, S1, S1, S1 | S0, S1, S0, B0, S1, S0, S1 | S0, S1, B1, B1, S0, S0, S0 |
| S0, S1, B0, S1, S0, S0, S0 | S1, S1, S0, B0, S1, S0, S1 | S0, S1, B1, B1, S0, S0, S0 |
| S0, S1, B0, S1, S0, S0, S1 | S1, S1, S0, B0, S1, S0, S1 | S0, S1, B0, B0, S0, S0, S0 |
| S1, S1, B0, S1, S0, S1, S1 | S0, S1, S1, B1, S1, S0, S1 | S0, S1, B0, B0, S1, S0, S0 |
| S0, S1, B0, S0, S1, S0, S0 | S1, S1, S0, B1, S0, S1, S1 | S1, S1, B1, B1, S0, S0, S1 |

is obtained, and each quantum dot does not lie in an eigen-state. Even when this state is read, a text that is partially probabilistically different from the original recorded text is obtained similarly to the case of reading after decryption with incorrect reading key discussed above. Even when any mathematical unauthorized decryption is performed after that, the original plain text cannot be obtained.

The number of combinations of dot states before the measurement that produces a certain measurement result is infinite. Especially, when the state to be recorded is selected so that all the dot states after incorrect decryption are superposition states, every available text in a state before the measurement that produces a certain measurement result can be represented by the bit values. The unauthorized information user therefore cannot read the recorded information at all, and hence a perfect secrecy state is achieved.

Even when eigen-states are included in the states after the incorrect decryption, superposition states are always included due to agreement about state selection, and the bit values are propablistically different from those of the recorded information. The unauthorized information user cannot specify the correct decrypting operation of each bit, so that the user cannot specify in which bit the state changes propablistically. Therefore, all bits can change propablistically, and cannot specify the recorded information.

In the present invention, a method of unauthorized decryption by trying reading keys in a round-robin manner similarly to the mathematical encryption cannot be performed.

Universal decryption is described as the other method of unauthorized decryption. In the universal decryption, the same unitary transformation is applied to all states without specifying the individual base used for recording information, and thus all the recorded states are transformed to eigen-states. Actually, this is impossible. That is because A0 to B1 are selected so that unitary transformation UA for transforming A0 and A1 to eigen-states is different from unitary transformation UB for transforming B0 and B1 to eigen-states. Whichever unitary transformation is applied in a state where the base cannot be specified, superposition states always remain, and information different from the recorded information can be obtained by measurement.

For reading all correct information, the unauthorized information user must find the correct reading key in the initial decryption. However, when the number of reading key candidates is set sufficiently large, the success possibility of the estimation can be decreased to a practically negligible degree. In other words, the unauthorized information user that does not know the reading key cannot correctly read the information.

In the conventional mathematical encryption, perfect safety requires completely random information with length equal to that of recorded information. In the present invention, however, even when a reading key with length shorter than that of the recorded information is used, all the recorded information is invalidly decrypted only when the correct reading key is found in the initial decryption. Therefore, safety higher than that of the conventional mathematical encryption can be obtained more easily.

(Effect of Combined Use with Mathematical Encryption)

In the present invention, when the recorded information is previously mathematically encrypted, it cannot be directly determined whether correct information is read by correct decryption or incorrect information is read by incorrect decryption. That is because a measurement result of a superposition state is not distinguished from a measurement result of the eigen-state corresponding to the former measurement result. Therefore, when the recorded information is previously mathematically encrypted, an unauthorized information user, only after success in mathematical decryption, can recognize that decryption by a correct reading key has been performed. When the decryption is not performed with the correct reading key, the correct mathematical decryption is impossible. In other words, the unauthorized information user can know that a correct reading key has been used, only when the user has performed the decryption using the correct reading key and has achieved success in decryption of the mathematical cipher. This property is important in preventing unauthorized decryption.

The unauthorized information user can decrypt all recorded information at a time, and further can decrypt only part of the recorded information. The user tries a certain reading key candidate on part of the information, and, when the reading key is found to be incorrect, can try another key on the remaining part. Information in the parts that are decrypted and read using incorrect reading keys before the correct reading key is found becomes lost, but the unauthorized information user can obtain much information when much information amount remains after finding of the correct reading key.

In the present invention, when the recorded information is previously mathematically encrypted, an unauthorized information user can recognize success in decryption by the correct reading key only after success in mathematical decryption, as discussed above. Conversely, when the user does not fail in all mathematical decryptions, it cannot be concluded that the reading key is incorrect. In other words, for verifying one reading key candidate, all considered mathematical decryptions must be tried. Much time and many computer resources are required for trying the mathematical decryptions, so that the finding of the correct reading key is delayed.

It is assumed that there are n reading key candidates and m procedure candidates of mathematical decryption, reading with one reading key candidate requires s1 seconds, and one try of mathematical decryption procedure of a read cipher text requires s2 seconds. At this time, for example, the whole time required for tries of all reading key candidates and all mathematical decryption procedure candidates is expressed by
n×(s1+m×s2) seconds.
This time is longer than time n×s1 taken when mathematical encryption is not performed and time m×s2 taken when only mathematical encryption is performed. Therefore, even in the method of trying reading keys on respective parts, risk of specifying a correct reading key within a time period over which the information is meaningful can be reduced by the combined use with mathematical encryption.

(Change of Blocks and Periodicity in Encryption by Reading Key and Mathematical Encryption)

Either of a key of mathematical encryption and a reading key is formed of 21 bits and the same extending method is employed in the present embodiment. The mathematical encryption and the encryption by the reading key are therefore performed with the same 21 bit periodicity. ASCII code has 7 bit periodicity and hence coincides with the 21 bit periodicity. When all of ASCII code, the mathematical encryption, and the encryption by the reading key have the same periodicity, continuous information in the original plain text (3 characters corresponding to 21 bits) can be read by trying the decryption of the encrypted state every 21 bits and by using a correct reading key and a correct mathematical encryption key. An unauthorized information user judges the success in unauthorized decryption when the decrypted text has a characteristic to be possessed by the plain text. Therefore, the unauthorized information user easily judges the success in unauthorized decryption when such the continuous information in the original plain text is obtained.

In the example discussed above, when 21 top bits are decrypted with the correct reading key and correct mathematical encryption key and interpreted with ASCII code, “Thi” existing in the text inside the parentheses is obtained. When the plain text is a natural language, continuously appearing characters are unbalanced. The appearing frequency of “Thi” in an English text, for example, is clearly higher than that of “pR#”. Here, the “pR#” is ASCII interpretation of the 21 top bits of the text that has been read using the incorrect reading key “AAA” and correct mathematical encryption key “KEY”. Therefore, decryption of only a part allows verification of the reading key.

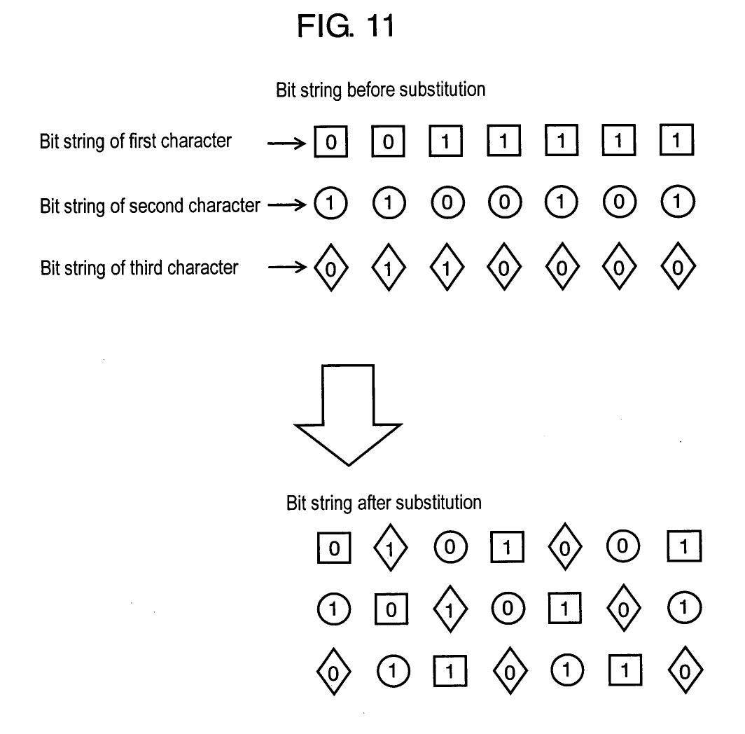

For avoiding this problem, the periodic unit specified by a reading key is required to be prevented from continuing in the plain text. As shown in FIG. 11, for example, mathematical encryption, bit substitution between different characters, and encryption by the reading key are sequentially performed. In this case, even when 21 top bits are decrypted with the correct reading key, it cannot be judged whether or not the decryption is correct. Therefore, the reading key must be tried in a large part, and hence amount of information damaged before finding of the correct reading key is increased.

(No-Cloning Nature)

Copy without read is impossible in principle due to the no-cloning theorem of quantum mechanics. When the quantum information recording medium of the present invention and the recorded information are used for authentication, a counterfeit-resistant card for authentication can be produced.

### Second Embodiment

(Fundamental Elements of Recording Device for Performing Second Embodiment)

Performing of the method according to claim 2 of the present invention requires the following elements:
a quantum cipher writing device that selects a specific physical quantity from at least two or more incompatible physical quantities in response to information to be recorded and information called a reading key, uses it as a base, and creates a quantum state corresponded to the information;
a quantum cipher recording medium for storing the state; and
a quantum cipher reading device for selecting a specific physical quantity in response to the reading key information and for reading it.
   In the second embodiment, a spin is used as a quantum state of the claim 2 of the present invention.

When components in different directions of a spin are used as the incompatible physical quantities, a device for turning the spin to a specific direction is the quantum cipher writing device, and a device that selects a specific direction from at least two spin directions in response to the reading key information and reads a spin component of the quantum cipher recording medium is the quantum cipher reading device.

These devices can be achieved by various methods, but a method using a quantum dot similarly to the first embodiment is optimum for the present embodiment and hence is described here.

(Devices for Second Embodiment)

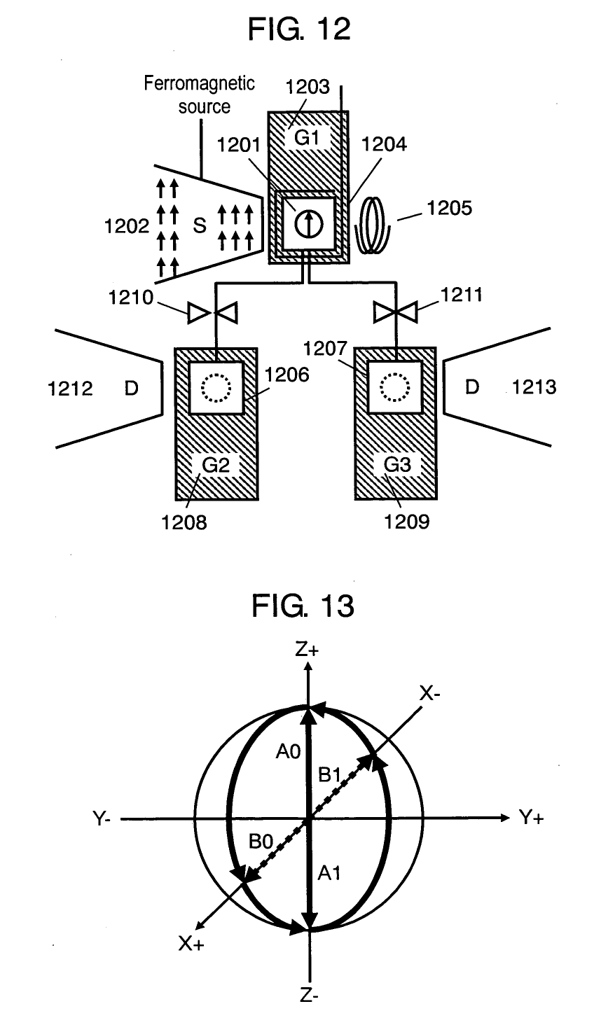

A configuration of the quantum cipher recording device in accordance with the second exemplary embodiment is shown in FIG. 12. The recording device includes the following elements:
recording quantum dot 1201 for holding the spin of the extra electron:
ferromagnetic body source 1202 for supplying a spin-polarized electron to the recording quantum dot;
first gate electrode 1203 for varying the potential of the recording quantum dot;
first spin rotating coil 1204 for applying a vertical magnetic field to the extra electron:
second spin rotating coil 1205 for applying a horizontal magnetic field to the extra electron:
first reading quantum dot 1206 for measuring the Z-component of the spin of the extra electron:
second reading quantum dot 1207 for measuring the X-component of the spin of the extra electron:
second gate electrode 1208 for varying the potential of the first reading quantum dot;
third gate electrode 1209 for varying the potential of the second reading quantum dot;
spin valve 1210 for passing only the spin-polarized electron in the positive Z-axis direction from the recording quantum dot to the first reading quantum dot;
spin valve 1211 for passing only the spin-polarized electron in the positive X-axis direction from the recording quantum dot to the second reading quantum dot;
drain electrode 1212 for extracting the extra electron from the first reading quantum dot; and
drain electrode 1213 for extracting the extra electron from the second reading quantum dot.
   This is a fundamental configuration unit for recording 1 bit of information. For holding 1 or more bits of information, a required number of fundamental configuration units are prepared. All the elements can be integrated on a board such as a normal semiconductor memory.

Additionally, the recording device has a control circuit (not shown) that controls potentials of the electrodes and coil current and an output circuit (not shown) that outputs signal 0 or 1 in response to difference in drain current value flowing through the drain electrode. Similarly to the device for the first embodiment, a shield and a cooling device are provided as necessary.

The configuration of the device is fundamentally similar to the device for the first embodiment. A device for selecting one direction from two different directions and measuring the spin component is used in the second embodiment. While, in the first embodiment, only a means for measuring only a specific component in one direction is used as a means for measuring the spin direction. Selecting of one direction from two different directions and measuring of the spin component require the following elements:
two spin valves 1210 and 1211 corresponding to different components;
two reading quantum dots 1206 and 1207 connected to recording quantum dot 1201; and
a mechanism for measuring existence of an extra electron in each quantum dot.
   The control circuit can select a spin valve and reading quantum dot to be used for the spin measurement.

The second exemplary embodiment requires the following elements:
a device for turning the spin to the specific direction in response to information to be recorded and information called a reading key;
a quantum recording medium for holding the spin; and
a device for reading the spin component in the specific direction in response to the reading key information.
   Even when the processes are performed by a method other than the method discussed above, naturally, this does not affect the present invention.

All of the quantum cipher writing device, the quantum cipher recording medium, and the quantum cipher reading device are integrated; however, they may be separated from each other.

(Recording/Reproducing Method of Second Embodiment)

Recording and reproducing procedures of information using the medium and the devices are described hereinafter.

(Recording)

An information recording person firstly prepares information to be recorded. It is preferable to previously mathematically encrypt the information to be recorded, but it is not absolutely necessary. As an example of the information to be recorded, information generated by representing the text in “ ” of “This is a pen.” with ASCII code and by encrypting the ASCII representation with key “KEY” is used. Here, this text is taken in the conventional art.

The recording person inputs the information to be recorded and the reading key to a control unit of the recording device. The control unit of the recording device selects a quantum state to be created in each recording quantum dot based on the information. The reading key is information for specifying a base used for recording each recording quantum dot, similarly to the first embodiment. The used base cannot be specified without this information, namely the base can be specified only when the information exists. The algorithm for specifying the base from the reading key has been described in the first embodiment, and hence is not described here.

The quantum state is selected so as to satisfy the following conditions:
a measured value corresponding to the recorded information is obtained and the information is correctly read when the measurement is performed with a correct measurement physical quantity; and
the recorded information cannot be specified from the measurement value when the measurement other than the correct measurement of the physical quantity is performed.

This selection can be realized by assuming the following conditions:
state A0 is set when information to be recorded is 0 and the base specified by the reading key is A;
state A1 is set when information to be recorded is 1 and the base specified by the reading key is A;
state B0 is set when information to be recorded is 0 and the base specified by the reading key is B; and
state B1 is set when information to be recorded is 1 and the base specified by the reading key is B,
   and by selecting states A0 to B1 as follows.

A0 and A1 are two eigen-states of physical quantity A, and B0 and B1 are two eigen-states of physical quantity B that is incompatible with physical quantity A. In the present embodiment, components in different directions of the spin are used as the incompatible physical quantities. At this time, A0 and A1 are eigen-states for a certain direction measurement (hereinafter referred to as “MA”), and B0 and B1 are eigen-states for another direction measurement (hereinafter referred to as “MB”).

In the selecting method of two direction measurements, it is required that two directions are not parallel. The nonparallel components of the spin are incompatible physical quantities. Ideally, it is preferable that the directions are orthogonal. When MA is assumed as measurement in the Z-axis direction and MB is assumed as measurement in the X-axis direction, these directions are not parallel, and the following states can be selected. A0 is the state where the spin points to the positive Z-axis direction, A1 is the state where the spin points to the negative Z-axis direction, B0 is the state where the spin points to the positive X-axis direction, and B1 is the state where the spin points to the negative X-axis direction.

(Write)

The quantum cipher writing device creates the selected quantum states in the quantum cipher recording medium. In other words, only one extra electron is injected into each recording quantum dot 1201, a magnetic field is controlled and applied to each quantum dot with coils 1204 and 1205 in response to the state to be created in each recording quantum dot 1201, and the spin in recording quantum dot 1201 is turned to the direction specified above (positive Z-axis direction in A0, negative Z-axis direction in A1, positive X-axis direction in B0, and negative X-axis direction in B1).

(Retention)

The quantum state in the quantum cipher recording medium is retained until read. The direction of the spin of the extra electron injected into each recording quantum dot 1201 is retained until the read. For retention, an undesired external magnetic field and electromagnetic wave are prevented from being applied to each recording quantum dot 1201.

Here, the information recording person delivers, to an authorized information user, the quantum cipher recording medium, the reading key, a key used for decrypting a mathematical cipher when the mathematical encryption has been performed, the algorithm used for specifying the base based on the reading key, and the algorithm used for decrypting the mathematical cipher.

The processes up here are the same as those in the first embodiment.

(Read)

Decryption is not performed in the second embodiment, differently from the first embodiment. In the second embodiment, a physical quantity for each bit is selected and measured in response to the information of the reading key by the quantum cipher reading device. In the present example, a spin component to be measured is selected every quantum dot. This selection can be performed by selecting which are used of two spin valves 1210 and 1211 coupled to recording quantum dot 1201 and two reading quantum dots 1206 and 1207. The selection of the valve and dot can be performed by adjusting potentials of second gate electrode 1208 and third gate electrode 1209 so that the extra electron is carried to the used-side recording quantum dot.

The authorized information user inputs the reading key information into the control unit and specifies which physical quantity of each bit is read. The authorized information user knows the reading key and algorithm for specifying the base used for recording each bit, so that the user can specify the base of each bit and physical quantity to be measured. Physical quantity A is measured when base A can be specified, and physical quantity B is measured when base B can be specified.

In this embodiment,

| | | |
|---|---|---|
| MB, MA, MB, MA, MA, MA, MA | MB, MA, MA, MB, MA, MA, MA | MB, MA, MB, MB, MA, MA, MB |
| MB, MA, MB, MA, MA, MA, MA | MB, MA, MA, MB, MA, MA, MA | MB, MA, MB, MB, MA, MA, MB |
| MB, MA, MB, MA, MA, MA, MA | MB, MA, MA, MB, MA, MA, MA | MB, MA, MB, MB, MA, MA, MB |
| MB, MA, MB, MA, MA, MA, MA | MB, MA, MA, MB, MA, MA, MA | MB, MA, MB, MB, MA, MA, MB |
| MB, MA, MB, MA, MA, MA, MA | MB, MA, MA, MB, MA, MA, MA | MB, MA, MB, MB, MA, MA, MB |

is obtained. Here, MA indicates measurement of physical quantity A, and MB indicates measurement of physical quantity B.

In the present example, MA indicates measurement of the component in the Z-axis direction, and MB indicates measurement of the component in the X-axis direction. States A0 and A1 are eigen-states with respect to measurement MA, and states B0 and B1 are eigen-states with respect to measurement MB.

When the measurement of each quantum state is performed so as to provide an eigen-state, a reading result is always represented as

| | | |
|---|---|---|
| 0011111 | 0101101 | 0110000 |
| 0111000 | 1100101 | 0110000 |
| 0111000 | 1100101 | 0111000 |
| 1101011 | 0110101 | 0111100 |
| 0100101 | 1101011 | 1111001. |

This is the just recorded mathematically-encrypted information. Therefore, when the authorized information user decrypts this information using cipher key “KEY” of the mathematical cipher and interprets it according to the ASCII code table, the user can obtain the text in “ ” of “This is a pen.” that the recording person intends to send.

Thus, the quantum cipher recording device of the present invention can transmit the correct information to the authorized information user.

(Unauthorized Read)

The unauthorized decryption by an unauthorized information user is described hereinafter. It is assumed that the unauthorized information user can obtain a medium where information is recorded, but does not know the reading key or the mathematical cipher key. The processes until retention of information are the same as those of the authorized use of the information, so that the description of the processes is omitted.

Since the unauthorized information user does not know the reading key, the user cannot specify the physical quantity to be measured for each bit. Similarly to the unauthorized decryption of the mathematical encryption, an unauthorized decryption method in which the unauthorized information user tries reading keys in a round-robin manner is described. For example, “AAA” is firstly used as a reading key candidate.

The measurement specified by the reading key candidate “AAA” is represented as

| | | |
|---|---|---|
| MB, MA, MA, MA, MA, MA, MB | MB, MA, MA, MA, MA, MA, MB | MB, MA, MA, MA, MA, MA, MB |
| MB, MA, MA, MA, MA, MA, MB | MB, MA, MA, MA, MA, MA, MB | MB, MA, MA, MA, MA, MA, MB |
| MB, MA, MA, MA, MA, MA, MB | MB, MA, MA, MA, MA, MA, MB | MB, MA, MA, MA, MA, MA, MB |
| MB, MA, MA, MA, MA, MA, MB | MB, MA, MA, MA, MA, MA, MB | MB, MA, MA, MA, MA, MA, MB |
| MB, MA, MA, MA, MA, MA, MB | MB, MA, MA, MA, MA, MA, MB | MB, MA, MA, MA, MA, MA, MB. |

However, this operation is not perfectly match with the authorized measurement. When recording states A0 and A1 undergo measurement MB (measurement of physical quantity B), for example, these states are not eigen-states with respect to the measurement and hence either 0 or 1 is probabilistically resulted from the measurement. When states B0 and B1 undergo measurement MA, a similar result is obtained. Therefore, when measurement is performed according to the command by an incorrect reading key, resultant information is changed from the original information recorded by the recording person. The original information cannot be perfectly specified from the probabilistically changed information by any mathematical operation, similarly to the first embodiment. Once read is performed with the incorrect reading key, the original information cannot be reproduced and another reading key cannot be tried, similarly to the first embodiment.

Unauthorized decryption by universal measurement is impossible in this case, either. In the universal measurement, when either of eigen-states of physical quantity A and physical quantity B is measured, the measurement result is always an eigen-state. The universal measurement is not realized when physical quantity A and physical quantity B are incompatible with each other. Therefore, the unauthorized information user cannot correctly read the information. Perfect copy without read cannot be performed, either.

Therefore, the second embodiment can provide safety similar to that of the first embodiment.

### Third Embodiment

(Fundamental Elements of Recording Device for Performing Third Embodiment)

Performing of the method according to claim 3 of the present invention requires the following elements:
a quantum cipher writing device for creating a quantum state in a specific phase that periodically varies between an eigen-state and a superposition state in response to information to be recorded and information called a reading key;
a quantum cipher recording medium for storing the periodic state variation with the phase kept; and
a quantum cipher reading device for measuring the quantum state at a specific phase time in response to reading key information.
   These devices can be realized in various methods. In the third embodiment, a method using a precessing spin as the quantum state of claim 3 of the present invention is described.

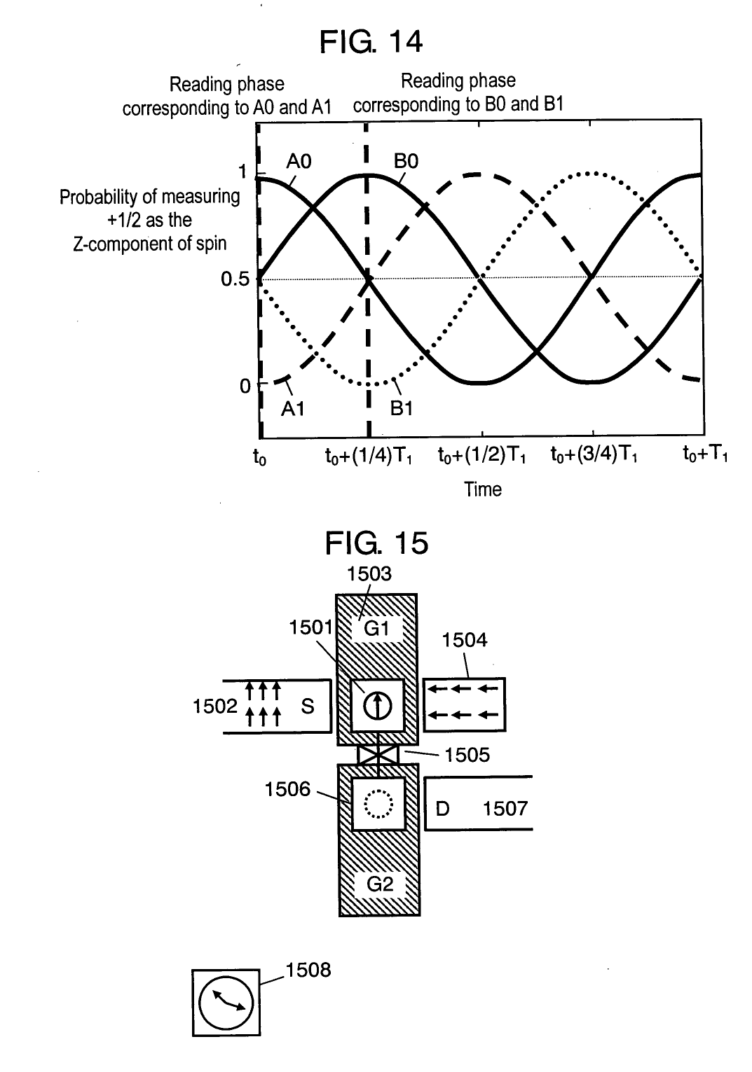

As the quantum state that periodically varies between the eigen-state and the superposition state, the precession of a spin can be employed. For example, the precession of a spin rotating about the Y-axis on the XZ plane shown in FIG. 13 is considered. At this time, the spin periodically becomes parallel or nonparallel with the Z-axis. The spin lies in the eigen-state in measurement in the Z-axis direction performed when the spin is parallel with the Z-axis, but the spin lies in the superposition state in measurement in the Z-axis direction performed when the spin is parallel with the other direction such as the X-axis. Measurement result of +½ or −½ is always obtained when the Z-axis component is measured at a phase time when the spin is parallel with the Z-axis, but one of +½ and −½ is obtained probabilistically when the spin is not parallel with it. Variation of the probability of occurrence of +½ with respect to time is shown as the measurement result in FIG. 14. Here, t0 is a time when the spin points to the negative Z-axis direction, and T is the period of the precession of the spin. The precession is periodic motion, so that the state at time t and the state at time t+nT (n is any integer) are the same. In other words, by specifying a time when the spin lies in the same state as that at reference time t0, namely time t0+nT (n is any integer), and an elapsed time from that time, time (phase time) in the periodic motion of the system can be specified. Difference in direction at time t0, namely difference in phase, causes difference in probability of measuring +½ at each phase time. FIG. 14 shows probabilities in four phase states (A0, A1, B0, and B1) shown in FIG. 13.

When the method of the present invention is performed using a spin, the use of a quantum dot is optimal similarly to the first embodiment and is hence described here.

A configuration of the quantum cipher recording device in accordance with the third exemplary embodiment is shown in FIG. 15. The recording device includes the following elements:
recording quantum dot 1501 for holding the spin of an extra electron:
ferromagnetic body source 1502 for supplying a spin-polarized electron to the recording quantum dot;
first gate electrode 1503 for adjusting the potential of the recording quantum dot;
static magnetic field source 1504 for periodically rotating the direction of the spin of the extra electron in the recording quantum dot;
spin valve 1505 for passing only the spin-polarized electron in the positive direction with respect to the measurement direction;
reading quantum dot 1506 for measuring the spin of the extra electron:
drain electrode 1507 for measuring the charge of the reading quantum dot: and
time circuit 1508 for performing spin injection and charge transport by controlling phase time.

This configuration is essentially similar to the device for the first embodiment and the device for the second embodiment, but different from them in two aspects. The first aspect is as follows. In the first embodiment or the second embodiment, a magnetic field is generated using a spin control coil only in writing, the spin is rotated by a required angle, the magnetic field is stopped after the required rotation, and the spin is held in the state having no magnetic field. While, in the third embodiment, the magnetic field is applied to the spin over the holding time period to continue the rotation.

This rotation is performed so as to keep the rotation axis, rotation plane, and angular velocity constant over the recording holding time period. In this condition, the spin pointing to a certain direction at a certain time turns to the other direction with the passage of time, but the spin turns to the original direction after a lapse of a certain time called a period. The period is derived by multiplying inverse of the angular velocity by 2π. The rotation axis, rotation plane, period, and rotation direction are uniquely determined by specifying a characteristic of a particle with a spin and an applied magnetic field. For keeping the rotation axis, rotation plane, and period constant, a magnetic field that is constant in time and in space within a spin moving range is applied to the spin.

In the present invention, the rotation axis and rotation plane are selected so that two eigen-states in the spin direction to be measured are included in a lapse state in the rotation. When the Z-axis component is measured, for example, the Z-axis must be set to be included in the rotation plane. For example, the Y-axis is set as the rotation axis so that the XZ-plane is the rotation plane. For setting the XZ-plane as the rotation plane, the static magnetic field that is uniform in time and in space and parallel with the Y-axis direction is simply required in a state where the spin exists on the XZ-plane.

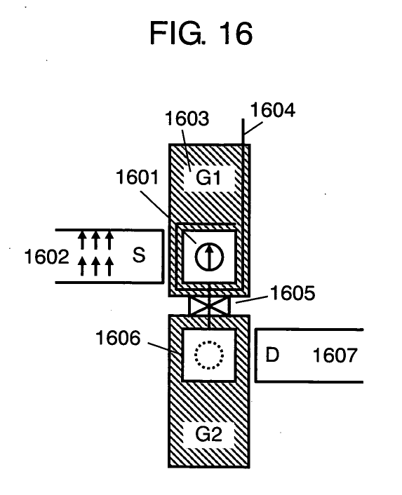

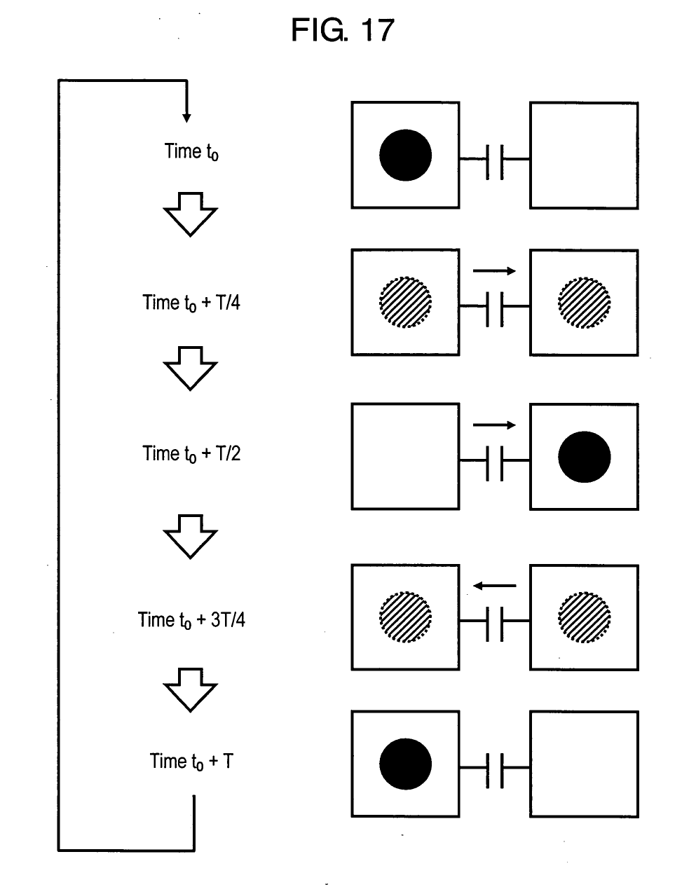

The magnetic field for generating the periodic motion is essentially continued to be applied, so that not an induced magnetic field by a coil but a magnetic field of a magnetized ferromagnetic body can be used. Static magnetic field source 1504 as the ferromagnetic body generates this magnetic field. In the method using the ferromagnetic body, power consumption is reduced because continuous current is not required. In the method using the ferromagnetic body, the application of the magnetic field cannot be stopped when the ferromagnetic body cannot be separated from the medium, so that the application of the magnetic field remains also at the writing and reading times. When the writing and reading are performed in the state where the magnetic field cannot be stopped, any variation of the operations over time causes an error. For increasing tolerance to the variation of the writing and reading over time, it is preferable to provide a mechanism for separating the ferromagnetic body as necessary, or to use a method of continuing to apply the induced magnetic field by a coil. For example, static magnetic field generating coil 1604 may be prepared instead of the ferromagnetic body as shown in FIG. 16. There is a problem of always consuming the power when the magnetic field is induced by the coil, but the magnetic field can be stopped by stopping the coil current when the rotation of the spin is not required, for example at the writing and reading times. Continuous application of the magnetic field is required only in holding also in the third embodiment, the error due to the variation of the operations over time can be prevented by stopping the magnetic field at the writing and reading times. The method using the coil is more excellent than the method using the ferromagnetic body, because a constant magnetic field can be continued to be accurately applied by controlling the current value in the method using the coil.

The phase of the periodically moving quantum state must be controlled in the present embodiment. However, when the magnetic field applied to the recording quantum dot is not stopped, this phase control can be performed only with the timing of injecting an electron into the recording quantum dot. When the magnetic field applied to the recording quantum dot can be freely started, stopped, or restarted, the phase can be adjusted with the starting time and the stopping time. Also in this aspect, the method using the induced magnetic field by the coil is more advantageous.

Periodic motion states with different phases must be created and kept in respect to the information to be recorded and reading key information in the present invention. For this purpose, starting time of the precession is controlled by injecting the electron into the recording quantum dot under time management, or the static magnetic field is stopped at the injection time and the application of the magnetic field is started at a time when a desired phase is obtained. In either case, time control is required for writing. In the present invention, time control must be performed also at the reading time, and the reading must be performed at an appropriate phase time specified by the reading key. The control unit therefore must perform the writing and reading under time management, differently from the first and second embodiments. This can be performed by a typical time circuit. A spin group precessing in the same period is prepared in addition to the spin used for recording, and a mechanism capable of specifying the time with their measurements may be formed.

(Recording/Reproducing Method of Third Embodiment)

Recording and reproducing procedures of information using the quantum cipher recording device are described hereinafter.

(Recording)

An information recording person firstly prepares information to be recorded. As an example of the information to be recorded, the information is taken which is generated by representing the text in “ ” of “This is a pen.” with ASCII code and by encrypting the ASCII representation with key “KEY”. Here, “This is a pen.” is taken in the conventional art. The recording person prepares the information for specifying a base called a reading key and the algorithm for specifying the base from the reading key, similarly to the first and second embodiments. The characteristics required for the reading key and the algorithm are similar to those in the first and second embodiments. Based on the information, the present embodiment is also described using the same reading key and the algorithm as those in the first embodiment.

The recording person inputs the information to be recorded and the reading key to the control unit of the quantum cipher writing device. The control unit selects a phase of a quantum state to be created in each recording quantum dot.

The selecting method of the phase of the quantum state is set as follows;
the measurement is performed at a correct phase time, hence a measured value corresponding to the information to be recorded can be obtained, and the information can be read correctly; but
the correct phase time cannot be specified without knowing the reading key, and the measurement at an incorrect phase time disables the recorded information from being specified based on the measurement result.

This selection can be realized by assuming the following conditions:
state A0 is set when information to be recorded is 0 and the base specified by the reading key is A;
state A1 is set when information to be recorded is 1 and the base specified by the reading key is A;
state B0 is set when information to be recorded is 0 and the base specified by the reading key is B; and
state B1 is set when information to be recorded is 1 and the base specified by the reading key is B,
   and by selecting states A0 to B1 as follows.

A0 is a phase state that becomes eigen-state S0 at phase time PA, A1 is a phase state that becomes another eigen-state S1 at phase time PA, B0 is a phase state that becomes eigen-state S0 at phase time PB different from PA, and B1 is a phase state that becomes eigen-state Si at phase time PB. States A0 to B1 are selected so that any phase time when all states are eigen-states does not exist.

As an example satisfying these conditions, the states shown in FIG. 14 can be taken. In other words, the phases of state A0 and state A1 are shifted from each other by ½ period, the phases of state B0 and state B1 are shifted from each other by ½ period, and the phases of state A0 and state B0 are shifted from each other by ¼ period.

(Write)

The previously determined quantum states are created in the quantum cipher recording medium with the quantum cipher writing device. In the present embodiment, only one extra electron is injected into each recording quantum dot, and a specific phase state is created in each recording quantum dot in response to the state to be created in each recording quantum dot 1501. It is aware that time management is required for controlling the phase in the present embodiment differently from the first and second embodiments. Even when spins point to the same direction at the moment of the electron injection into the recording quantum dot, any difference in injection time essentially causes difference in phase. When a constant magnetic field is applied after electron injection and only the spin pointing to a specific direction is injected into recording quantum dot 1501, the spin is injected at a time corresponding to the phase to be generated. The time management is performed by time circuit 1508. When injection angle of the spin can be controlled, the spin can be injected at an arbitrary time while the angle is adjusted so as to provide the phase to be generated. When the magnetic field for rotating the spin can be stopped at a writing time, the electron can be injected at any time and the phase can be controlled by application starting time of the magnetic field for rotating the spin.

(Retention)

The periodically varying phase of the quantum state in the quantum cipher recording medium is retained until read. In the present embodiment, the rotation at a constant angular velocity is kept while the precessing phase of the spin of the extra electron is kept. In other words, the magnetic field uniform in time and space for keeping a required rotation is allowed to be applied to each recording quantum dot, but an undesired external magnetic field and an electromagnetic wave are prevented from being applied to the dot. In this condition, the information recording person delivers the medium, information of the reading key, key information used for decrypting a mathematical cipher to an authorized information user.

(Read)

Decryption is not performed in the third embodiment, similarly to the second embodiment. In the third embodiment, only measurement of one physical quantity (spin component in one direction) is required differently from the second embodiment, and a phase time of measurement is selected according to the information of the reading key.

This selection can be performed by specifying the phase time when an electron is carried from the recording quantum dot to the reading quantum dot.

The authorized information user reads each bit of the quantum cipher recording medium at a specific phase time in response to the base specified by the reading key using the quantum cipher reading device.

Since the reading key used for specifying the base is disclosed to the authorized information user, the user can specify a phase time when each state becomes an eigen-state. Base A becomes an eigen-state at phase time PA and base B becomes an eigen-state at phase time PB, so that each bit is measured at this phase time. In the present embodiment, phase time for each bit is described as

| | | |
|---|---|---|
| PB, PA, PB, PA, PA, PA, PA | PB, PA, PA, PB, PA, PA, PA | PB, PA, PB, PB, PA, PA, PB |
| PB, PA, PB, PA, PA, PA, PA | PB, PA, PA, PB, PA, PA, PA | PB, PA, PB, PB, PA, PA, PB |
| PB, PA, PB, PA, PA, PA, PA | PB, PA, PA, PB, PA, PA, PA | PB, PA, PB, PB, PA, PA, PB |
| PB, PA, PB, PA, PA, PA, PA | PB, PA, PA, PB, PA, PA, PA | PB, PA, PB, PB, PA, PA, PB |
| PB, PA, PB, PA, PA, PA, PA | PB, PA, PA, PB, PA, PA, PA | PB, PA, PB, PB, PA, PA, PB. |

The measurement is performed at the phase time when each quantum state becomes an eigen-state, so that the reading result always becomes as follows,

| | | |
|---|---|---|
| 0011111 | 0101101 | 0110000 |
| 0111000 | 1100101 | 0110000 |
| 0111000 | 1100101 | 0111000 |
| 1101011 | 0110101 | 0111100 |
| 0100101 | 1101011 | 1111001. |

This is just the recorded and mathematically encrypted information. Therefore, when decryption is performed using cipher key “KEY” of the mathematical encryption and interpretation is performed according to the ASCII code table, the authorized information user can obtain the text in “ ” of information “This is a pen.” intended to be sent by the recording person.

Thus, the quantum cipher recording device of the present invention can transmit the correct information to the authorized information user.

(Unauthorized Read)

The unauthorized decryption by an unauthorized information user is described hereinafter. It is assumed that the unauthorized information user can obtain the medium where information is recorded, but does not know the reading key or the mathematical cipher key. The processes until retention of information are the same as those of the authorized use of the information, so that the description of the processes is omitted.

Since the unauthorized information user does not know the reading key, the user cannot specify the correct phase time of measurement for each bit. Similarly to the unauthorized decryption of the mathematical encryption, an unauthorized decryption method in which the unauthorized information user tries reading keys in a round-robin manner is described. For example, “AAA” is firstly used as a reading key candidate.

The measurement phase specified by reading key candidate “AAA” is represented as

| | | |
|---|---|---|
| PB, PA, PA, PA, PA, PA, PB | PB, PA, PA, PA, PA, PA, PB | PB, PA, PA, PA, PA, PA, PB |
| PB, PA, PA, PA, PA, PA, PB | PB, PA, PA, PA, PA, PA, PB | PB, PA, PA, PA, PA, PA, PB |
| PB, PA, PA, PA, PA, PA, PB | PB, PA, PA, PA, PA, PA, PB | PB, PA, PA, PA, PA, PA, PB |
| PB, PA, PA, PA, PA, PA, PB | PB, PA, PA, PA, PA, PA, PB | PB, PA, PA, PA, PA, PA, PB |
| PB, PA, PA, PA, PA, PA, PB | PB, PA, PA, PA, PA, PA, PB | PB, PA, PA, PA, PA, PA, PB. |

However, this phase is not perfectly match with the authorized reading phase. When recording states A0 and A1 are measured in phase PB, for example, these states are not eigen-state in this measurement phase and hence either 0 or 1 is probabilistically resulted from the measurement. When states B0 and B1 are measured in phase PA, a similar result is obtained. Therefore, when measurement is performed according to the command by an incorrect reading key, resultant information is changed from the original information recorded by the recording person. The original information cannot be perfectly specified from the probabilistically changed information by any mathematical operation, similarly to the first and second embodiments. Once read is performed with the incorrect reading key, the original information cannot be obtained and another reading key cannot be tried, similarly to the first and second embodiments. Since the phase is selected so that phase time when all states are eigen-states does not exist, incorrect reading result is obtained even when the measurement is performed at any time. Perfect copy cannot be performed without reading, similarly to the first and second embodiments.

Therefore, in the third embodiment, safety similar to those in the first and second embodiments can be obtained.

(Method Using Coupled Quantum Dot)

The present embodiment is not limited to the method using the spin. A method using a coupled quantum dot is described as another example. Similarly to the case of the spin, the physical property of the coupled quantum dot is firstly described prior to the description of the recording method.

(Coupled Quantum Dot)

The coupled quantum dot has a structure where two quantum dots are interconnected via a potential barrier such as a thin insulating film allowing tunneling. For the sake of convenience, two quantum dots are called a first quantum dot and a second quantum dot.

(Periodic Oscillation)

State variation of the coupled quantum dot is described with reference to FIG. 17.

It is assumed that one extra electron exists in one quantum dot of the coupled quantum dot, for example in the first quantum dot, and no extra electron exists in the other quantum dot of the coupled quantum dot (the second quantum dot) at time t0. Two quantum dots are separated from each other by the potential barrier allowing tunneling, so that the extra electron existing in the first quantum dot at a certain time can tunnel to the second quantum dot. While, an electron having tunneled to the second quantum dot can also return to the first quantum dot by tunneling.

When only one extra electron is contained in the quantum dots (coupled quantum dot) interconnected in a state allowing mutual tunneling, this extra electron periodically tunnels between the first quantum dot and the second quantum dot. In other words, even when an extra electron exists in the first quantum dot at a certain time, the extra electron starts to tunnel to the second quantum dot through the tunnel barrier to provide a state where the extra electron can exist in both of the first quantum dot and the second quantum dot. After a further lapse of time, the extra electron finishes tunneling to provide a state where the extra electron perfectly exists in the second quantum dot. After a further lapse of time, the extra electron starts to tunnel from the second quantum dot to the first quantum dot to provide a state where the extra electron can exist in both of the first quantum dot and the second quantum dot again. After a further lapse of time, a state where the extra electron perfectly exists in the first quantum dot, namely the initial state, is produced. Therefore, the movement to the second quantum dot and the return to the first quantum dot are repeated. This phenomenon is called coherent oscillation of the extra electron, or simply called oscillation.

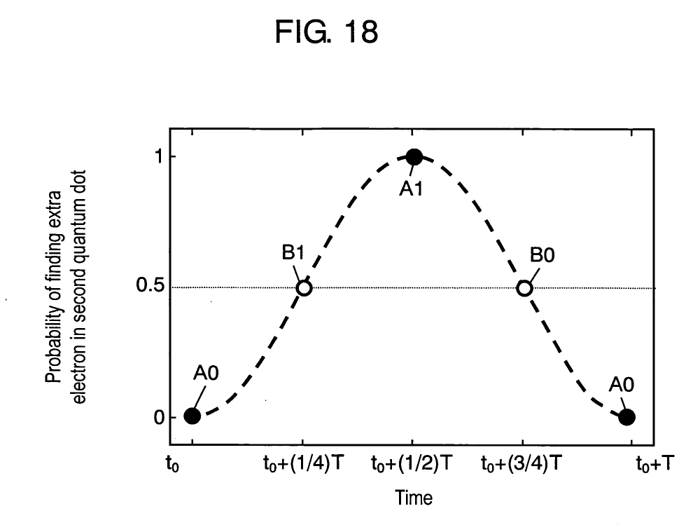

FIG. 18 shows variation over time of possibility of finding an extra electron in the second quantum dot when the extra electron is injected into the first quantum dot at time t0.

(Eigen-State)

When the number of extra electrons in the second quantum dot is measured while the extra electron perfectly exists in the first quantum dot, the result that the number of extra electrons is 0 at 100% probability is obtained. When the number of extra electrons in the second quantum dot is measured while the extra electron perfectly exists in the second quantum dot, a resultant number of extra electrons is 1 at 100% probability. These states are eigen-states with respect to the measurement of the number of extra electrons in the second quantum dot.

(Superposition State)

The state where the extra electron can exist in both of the first quantum dot and the second quantum dot again occurs at an intermediate point of the periodic oscillation. When the number of extra electrons in the second quantum dot is measured in this state, a resultant number of extra electrons is 0 at certain probability larger than 0 and smaller than 1, or 1 at the remaining probability. The state before the measurement is a superposition state of the state where the number of extra electrons in the second quantum dot is 0 and the number of extra electrons is 1.

(Irreversibility of Measurement)

When the number of extra electrons in the second quantum dot is measured, the quantum state changes at the same instant. When a measurement result that the number of extra electrons is 0 in a superposition state is produced, for example, the phase of the periodic motion of the extra electron varies at the same instant, and the superposition state changes to a state where the extra electron perfectly exists in the first quantum dot at the measurement time.

The state change due to the measurement is irreversible, and the reproduction of the state before the measurement by any operation is impossible.

(Unidentifiability)

Even when the measurement result that the number of extra electrons is 0 in the second quantum dot is produced, it cannot be identified whether the extra electron perfectly exists in the first quantum dot at the measurement time or the extra electron exists in a superposition state to accidentally result in 0. The measurement result shows only that the extra electron does not perfectly exist in the second quantum dot at the measurement time.

(No-Cloning Nature)

When the state of the extra electron is unknown, the state cannot be copied, similarly to the case of the spin.

(Retention)

The phase of the oscillation of the extra electron is kept when an electric field, electromagnetic wave, and heat are prevented from being applied from the outside to the coupled quantum dot. When the tunneling is prevented by an operation such as increase of the height of the potential barrier between two quantum dots in a midway through the oscillation of the extra electron, the superposition state corresponding to the stopped phase can be retained.

(Unitary Transformation)

When the tunneling is stopped, and then is allowed again by lowering the potential barrier of the coupled quantum dot in the superposition state, the oscillation restarts from the stopped phase. The phase can be varied by an arbitrary phase difference by controlling the time between the start and the stop of the tunneling. When the time between the start and the stop coincides with one period of the oscillation, the state does not change at all. When the tunneling is performed for a time period corresponding to the time period over which the extra electron moves perfectly from the first quantum dot to the second quantum dot, the extra electron in the first quantum dot can be moved to the second quantum dot. This phenomenon has the same characteristic as that of the spin rotation in a spin system. In other words, the phase of the oscillation of the extra electron is varied by allowing the tunneling for a certain time period. A relative variation amount can be specified, but varying the phase from an unknown phase results in another unknown phase. Even when the phase is varied, when the measurement has not yet performed, the state perfectly is returned to the original state by additionally varying the phase by the amount derived by subtracting the former phase variation from the phase of one period. In other words, this phase variation is also unitary transformation.

### Fourth Embodiment

(Fundamental Elements of Recording Device for Performing Fourth Embodiment)

In a method of the fourth embodiment, the method of the first embodiment is performed using coupled quantum dot. Performing of the method of the fourth embodiment requires the following elements:
a device for creating (initializing) a specific quantum state in response to information to be recorded and information called a reading key;
a quantum cipher recording medium for storing the quantum state;
a device for performing unitary transformation in response to the reading key information; and
a device for finally measuring the quantum state.
   An extra electron in the coupled quantum dot is used in this quantum state.

(Devices for Fourth Embodiment)

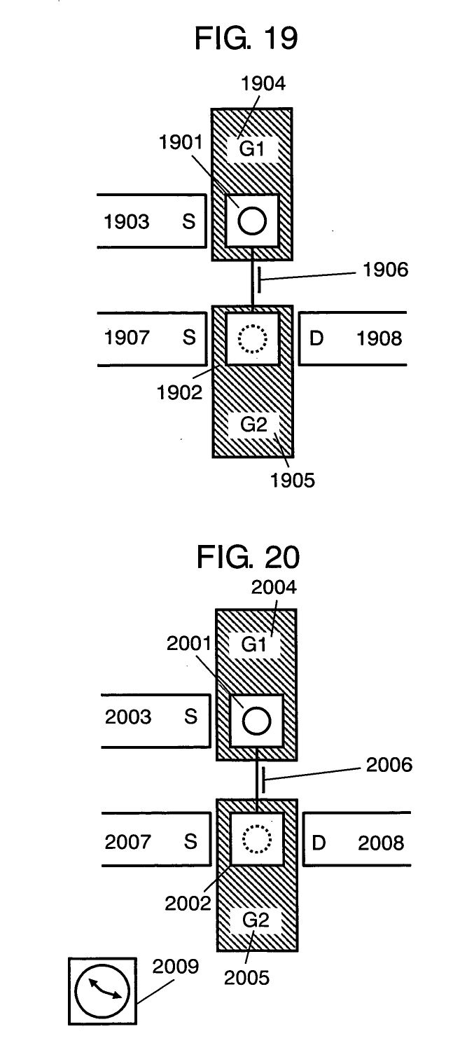

A configuration of the quantum cipher recording device in accordance with the fourth exemplary embodiment is shown in FIG. 19. The recording device includes the following elements:
first quantum dot 1901 for holding the extra electron:
second quantum dot 1902 connected to the first quantum dot through a barrier allowing tunneling;
source 1903 for supplying an electron to the first quantum dot;
first gate electrode 1904 for varying the potential of the first quantum dot;
second gate electrode 1905 for varying the potential of the second quantum dot;
potential electrode 1906 for varying the potential barrier between first and second quantum dots;
source electrode 1907 for measuring the number of extra electrons in the second quantum dot; and
drain electrode 1908 for measuring the number of extra electrons in the second quantum dot.
   This is a fundamental configuration unit for recording 1 bit of information. For holding 1 or more bits of information, a required number of fundamental configuration units are prepared. All the elements can be integrated on a board such as a normal semiconductor memory.

Additionally, the recording device has a control circuit (not shown) that controls potentials of the electrodes and an output circuit (not shown) that outputs signal 0 or 1 in response to difference in current value from the drain electrode. Low temperature is advantageous for keeping the state of the extra electron for a long time, so that a cooling device may be added to the fundamental configuration. Interaction with an electromagnetic field also can cause recording error, so that the memory may be covered with a shield for cutting off the electromagnetic field. The shield may be made of a conductor such as metal or photonic crystal.

This configuration allows the following operations:
initializing the extra electron in the quantum dot into a specific state in response to the information to be recorded and information called a reading key;
holding the state;
performing unitary transformation in response to the reading key information; and
finally measuring the number of extra electrons in the second quantum dot.
   These operations are described hereinafter.

(Fundamental Function of Each Element)

(Coupled Quantum Dot)

The coupled quantum dot is formed of two quantum dots, discussed above. Each quantum dot can be made of semiconductor such as Si or GaAs, or carbon nanotube, as described in the first embodiment. It is preferable that two quantum dots have substantially the same material and size. The energy levels of the extra electron that can exist in the quantum dots become discrete dependently on the sizes of the quantum dots due to a quantum mechanical effect. This energy level depends on the size and material of the quantum dots and the material surrounding the quantum dot. When there is a difference between respective energy levels in two quantum dots, the tunneling and oscillation do not essentially occur between two quantum dots. In the present embodiment, the oscillation is essentially caused between two quantum dots and is controlled by controlling the potential barrier between them, so that the sizes of the quantum dots are important to be equalized so as to match the energy levels with each other.

However, this property may be positively used. In other words, the oscillation can be controlled by controlling potential difference between the quantum dots instead of controlling the potential barrier. The oscillation can be allowed only during applying voltage to compensate the energy level difference of quantum dots and can be stopped by applying voltage that makes energy level difference.

(Initialization of Coupled Quantum Dot)

Source 1903 and first gate electrode 1904 are used for generating a state where only one extra electron exists in the coupled quantum dot. This method uses the Coulomb brockade phenomenon similarly to the first embodiment, so that the description is omitted.

(Unitary Transformation of Coupled Quantum Dot)

Just after the injection of the extra electron into first quantum dot 1901, the system lies in an eigen-state where the number of extra electrons is 0 in second quantum dot 1902. The potential barrier between first quantum dot 1901 and second quantum dot 1902 is adjusted using electrode 1906 to generate coherent oscillation between two quantum dots, and, after a lapse of a specific time, the potential barrier is raised to stop the oscillation, thereby putting the system into a specific eigen-state or a superposition state. When this state is retained, and the potential barrier is then adjusted so as to generate the oscillation again, the phase of the state can be varied.

(Read of Extra Electron)

A method of measuring the number of extra electrons in second quantum dot 1902 is finally described. This is the same as the method of measuring the number of extra electrons in the reading quantum dot of the first embodiment. In other words, the extra electron is made to tunnel to a drain connected to second quantum dot 1902, and the drain current by the extra electron itself is detected. Or, a field-effect transistor having the second quantum dot as the gate electrode is formed, and the current flowing from source 1907 to drain 1908 is measured.

All controls of the extra electron discussed above can be performed electrically using a typical transistor. All of the injection of the extra electron from the source into the first quantum dot, the potential control for adjusting the tunneling between the quantum dots, and electron transport to the drain are allowed by controlling respective potentials. These controls can be performed by a control circuit using a typical semiconductor. The detection of the drain current corresponding to the information reading result can be finally performed by the typical semiconductor circuit.

The fourth embodiment requires the following elements:
a device for initializing an extra electron into a specific quantum state in response to information to be recorded and information called a reading key;
a quantum cipher recording medium for storing the quantum state;
a device for unitary-transforming the state in response to the reading key information; and
a device for finally reading the number of extra electrons in the second quantum dot.
   The present embodiment is not affected by a method other than the above-mentioned method.

(Recording/Reproducing Method of Fourth Embodiment)

Recording and reproducing procedures of information using the quantum cipher recording device are described hereinafter.

(Recording)

An information recording person prepares information to be recorded, a reading key, and an algorithm for determining a base based on the reading key. Characteristics required for the reading key and the algorithm are the same as those in the first embodiment, so that the description of them is omitted.

The recording person selects a state to be created in the quantum cipher recording medium based on the base specified from the information to be recorded and the reading key.

The selecting method is completely the same as that of the first embodiment. The selecting method is determined so as to satisfy the following condition. When the measurement is performed after a correct decryption corresponding to each base, the measured value corresponding to the recorded information is obtained. While, the correct decryption cannot be performed when the base of each bit cannot be specified, and the recorded information cannot be specified from the measurement result when the measurement is performed in an unperformed state of the correct decryption. This selection is realized similarly to that of the first embodiment.

In other words, the selection is realized by assuming the following conditions:
state A0 is set when information to be recorded is 0 and the base specified by the reading key is A;
state A1 is set when information to be recorded is 1 and the base specified by the reading key is A;
state B0 is set when information to be recorded is 0 and the base specified by the reading key is B; and
state B1 is set when information to be recorded is 1 and the base specified by the reading key is B.

The determining method of states A0 to B1 is the same as that of the first embodiment. Difference between the fourth and first embodiments is as follows. The contents of unitary transformations UA and UB as the decrypting procedures are rotations of a spin in the first embodiment, or are controls of the phase of the coherent oscillation of the extra electron in the fourth embodiment.

For example, it is assumed that the phase is not shifted in UA and the coherent vibration is performed by ¼ of the period in UB. In this case, states A0 to B1 are described below:
A0 is a state where the extra electron perfectly exists in the first quantum dot (the probability of finding an extra electron in the second quantum dot is 0);
A1 is a state where the extra electron perfectly exists in the second quantum dot (the probability of finding an extra electron in the second quantum dot is 1); and
B0 and B1 are states where the probability of finding an extra electron in the second quantum dot is 50%.
   States B0 and B1 have different phase in the periodic oscillation, so that applying unitary transformation UB to these states causes different results because respective probabilities of finding an electron in the second quantum dot are 0 and 1.

Since the phase is not shifted in UA, the phase is not shifted either in UA−1. Since the coherent oscillation is performed by ¼ of the period in UB, the coherent oscillation is performed by ¾ of the period in UB−1.

(Write)

The selected quantum states are created in the quantum cipher recording medium using the quantum cipher writing device. For creating a specified superposition state in each quantum dot, the coherent oscillation is generated only for a required time period, and is stopped after the desired state is created.

In the quantum cipher recording device discussed above, the specified state is created in the following procedures. The voltages of the source and the first gate electrode are controlled, and only one extra electron is injected into each recording quantum dot. The tunneling time is then controlled by lowering the potential barrier between the first and second quantum dots in response to a state to be creased in each coupled quantum dot. After the specified state is created, the potential barrier is raised.

(Retention)

The quantum state in the quantum cipher recording medium is retained until decryption. In this condition, the information recording person delivers this medium, the information of the reading key, and the information of a key used for decrypting a mathematical cipher to the authorized information user.

(Decryption)

The authorized information user applies a decryption operation to the quantum state in the quantum cipher recording medium before reading with the quantum cipher decrypting device. The decrypting operation is unitary transformation for changing all quantum states in the coupled quantum dot to eigen-states.

The base used for recording each dot is specified, unitary transformation UA is applied to base A, and unitary transformation UB is applied to base B, similarly to the first embodiment. The recording key and the base determining algorithm are also disclosed to the authorized information user, so that the correct decryption can be performed for each dot.

Since it is assumed that the phase is not shifted in UA and the coherent vibration is performed by ¼ of the period in UB in the present embodiment, the decryption corresponds to these operations. The decryption can be performed by adjusting the potential barrier between the first and second quantum dots and by performing the coherent vibration only for a required time.

(Read)

After the system can be transformed into the eigen-state, the quantum cipher recording medium is measured by the quantum cipher reading device.

The number of extra electrons in the second quantum dot is measured in the present embodiment. This measurement can be performed using the drain current flowing due to potential difference between source 1907 and drain 1908. A signal indicating the magnitude of the drain current is output by a circuit. This circuit outputs 0 or 1 corresponding to the magnitude difference.

Since the decryption is previously performed, all the states in the coupled quantum dot are eigen-states. When the measurement is performed in this situation, a measurement result corresponding to the eigen-states is definitely output, similarly to the first embodiment. When the mathematical cipher is then decrypted, the original information can be obtained.

Thus, the quantum cipher recording device of the present invention can also transmit the correct information to the authorized information user.

(Unauthorized Read)

The unauthorized decryption by an unauthorized information user is described hereinafter. It is assumed that the unauthorized information user can obtain the medium where information is recorded but does not know the reading key or the mathematical cipher key. The processes until retention of the information are the same as those of the authorized use of the information, so that the description of the processes is omitted.

Since the unauthorized information user does not know the reading key, the user cannot specify the base of each recording quantum dot and hence cannot specify the correct decryption. Similarly to the first embodiment, when the correct decryption is not performed, the recorded information cannot be correctly read. The reading key cannot be found using the same part of the recording medium in a round-robin manner, and any decryption method other the round-robin manner does not exist, similarly to the first embodiment. No-cloning nature is the same. In other words, information safety equivalent to that in the first embodiment can be obtained in the fourth embodiment.

The reason why these characteristics match with each other is because properties (superposition state and no-cloning nature) of the quantum state commonly existing in the spin and the coupled quantum dot are used. Even when a quantum state other than the spin and the coupled quantum dot is used, the same characteristic can be obtained.

### Fifth Embodiment

(Fundamental Elements of Recording Device for Performing Fifth Embodiment)

In the fifth embodiment, the method of claim 3 of the present invention is performed using a coupled quantum dot. Performing of the method of the fifth embodiment requires the following elements:
a quantum cipher writing device for creating (initializing) a quantum state indicating periodic variation having a specific phase in response to information to be recorded and information called a reading key;
a quantum cipher recording medium for storing the quantum state; and
a quantum cipher reading device for measuring the quantum state in the specific phase in response to the reading key information.
   An extra electron in the coupled quantum dot is used in this quantum state.

(Devices for Fifth Embodiment)

A configuration of the quantum cipher recording device in accordance with the fifth exemplary embodiment is shown in FIG. 20. The recording device includes the following elements:
first quantum dot 2001 for holding the extra electron:
second quantum dot 2002 connected to the first quantum dot through a barrier allowing tunneling;
source 2003 for supplying an electron to the first quantum dot;
first gate electrode 2004 for varying the potential of the first quantum dot;
second gate electrode 2005 for varying the potential of the second quantum dot;
potential electrode 2006 for varying the potential barrier between first and second quantum dots;
source electrode 2007 for measuring the number of extra electrons in the second quantum dot;
drain electrode 2008 for measuring the number of extra electrons in the second quantum dot; and
clock circuit 2009 for controlling the phase time to perform injection and transportation of the electron.
   This is a fundamental configuration unit for recording 1 bit of information. For holding 1 or more bits of information, a required number of fundamental configuration units are prepared when 1 or more bits of information is required to be held. All the elements can be integrated on a board such as a normal semiconductor memory.

The configuration in the fifth embodiment is essentially substantially similar to that in the fourth embodiment. However, reading must be performed at a specific phase time in the fifth embodiment, so that the clock circuit for managing the reading is added.

(Recording/Reproducing Method of Fifth Embodiment)

Recording and reproducing procedures of information using the quantum cipher recording device are described hereinafter.

(Recording)

An information recording person firstly prepares information to be recorded. The information recording person prepares information that is called a reading key and used for specifying a base and a base determining algorithm, besides the information to be recorded, similarly to the third embodiment. Characteristics required for the reading key and the algorithm are the same as those in the third embodiment.

The recording person determines a state to be created in the quantum cipher recording medium, based on the base specified from the information to be recorded, the reading key, and the algorithm.

The determining method is the same as that of the third embodiment. In other words, a person knowing the reading key performs the measurement at a correct phase time, hence obtains a measured value corresponding to the recorded information, and can read the recorded information correctly. While, a person who does not know the reading key cannot specify the correct phase time, and, when the person performs the measurement at an incorrect phase time, the person cannot specify the recorded information from the measurement result.

This determination is realized similarly to that of the third embodiment by assuming the following conditions:
state A0 is set when information to be recorded is 0 and the base specified by the reading key is A;
state A1 is set when information to be recorded is 1 and the base specified by the reading key is A;
state B0 is set when information to be recorded is 0 and the base specified by the reading key is B; and
state B1 is set when information to be recorded is 1 and the base specified by the reading key is B,
   and by selecting states A0 to B1 as follows.

A0 is a phase state that becomes eigen-state S0 at phase time PA, A1 is a phase state that becomes another eigen-state S1 at phase time PA, B0 is a phase state that becomes eigen-state S0 at phase time PB different from PA, and B1 is a phase state that becomes eigen-state S1 at phase time PB. States A0 to B1 are selected so that any phase time when all states are eigen-states does not exist.

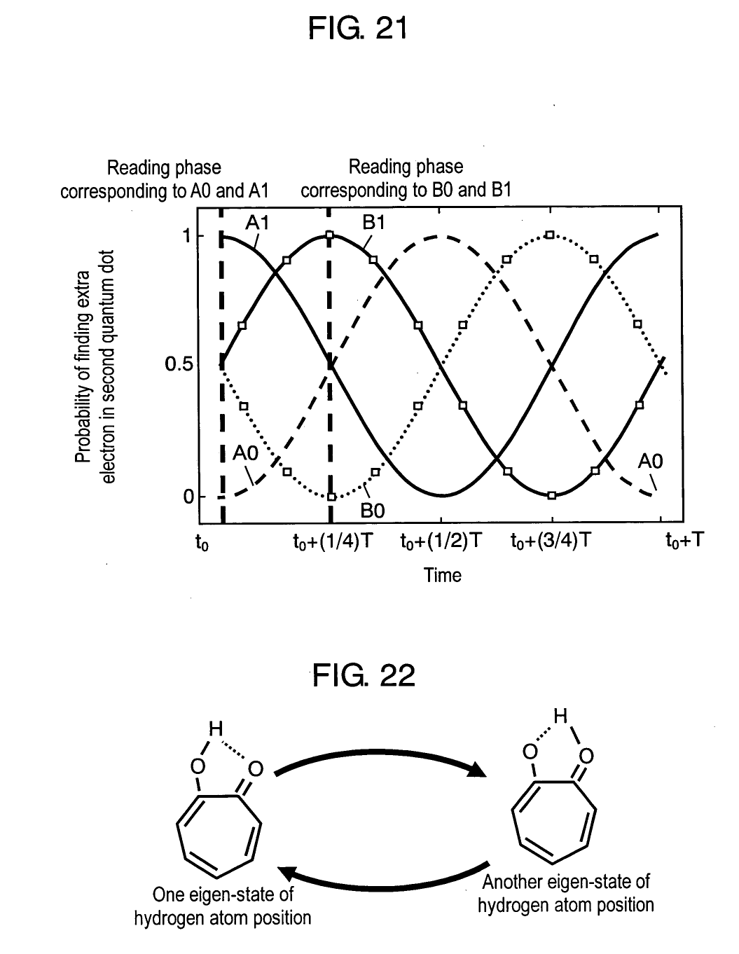

As an example satisfying these conditions, the states shown in FIG. 21 can be taken. In other words, the phases of state A0 and state A1 are shifted from each other by ½ period, the phases of state B0 and state B1 are shifted from each other by ½ period, and the phases of state A0 and state B0 are shifted from each other by ¼ period.

(Write)

A quantum state to be recorded in each bit of the quantum cipher recording medium is created with the quantum cipher recording device. Only one extra electron is injected into each coupled quantum dot, and a specific phase state is created in each coupled quantum dot in response to the state to be created. Time management is required similarly to the third embodiment. Difference in the injection time of the extra electron into first quantum dot 2001 essentially causes difference in phase. The extra electron is injected into first quantum dot 2001 at a time corresponding to the phase to be generated. In a configuration where the tunneling can be stopped for an arbitrary time period by controlling the height of the tunneling barrier, the required phase can be set by injecting the electron at an arbitrary time and then stopping the tunneling for an appropriate time period.

(Retention)

The state in the quantum cipher recording medium is retained until read. The phase of the coherent oscillation of the extra electron injected into each coupled quantum dot is retained. In other words, an undesired electric field and electromagnetic wave are prevented from being applied to each coupled quantum dot. In this condition, the information recording person delivers the medium, the reading key, an algorithm used for specifying a base, and a key and algorithm used for decrypting a mathematical cipher to an authorized information user.

(Read)

In the fifth embodiment, decryption is not performed similarly to the third embodiment, and measurement is performed at a specific phase time according to the information of the reading key. This measurement can be performed by specifying the phase time of measuring the extra electron existing in second quantum dot 2002.

The authorized information user determines the base of each bit according to the reading key and the base determining algorithm, and determines a measurement phase time based on the base. The extra electron is measured at phase time PA for base A or at phase time PB for base B. A potential difference is generated between source 2007 and drain 2008 at a desired phase time. States A0 and A1 are eigen-states at phase time PA, and states B0 and B1 are eigen-states at phase time PB. The authorized information user knowing the reading key can therefore measure each recording quantum dot in a phase in which the dot state is an eigen-state.

Since each recording quantum dot is measured in the eigen-state, the reading result is always the recorded and mathematically encrypted information. The authorized information user can therefore obtain the information intended to be sent by the recording person by performing the decryption using the cipher key of the mathematical cipher.

The correct information can be transmitted to the authorized information user also by the quantum cipher recording device of the present invention.

(Unauthorized Read)

The unauthorized decryption by an unauthorized information user is described hereinafter. It is assumed that the unauthorized information user can obtain a medium where information is recorded, but does not know the reading key or the mathematical cipher key. The processes until retention of information are the same as those of the authorized use of the information, so that the description of the processes is omitted.

Since the unauthorized information user does not know the reading key, the user cannot specify the correct phase time of measurement for each coupled quantum dot. Measurement at an incorrect phase time can be performed. When recording states A0 and A1 are measured at phase time PB, for example, the states are not eigen-states in these phases and hence either 0 or 1 is probabilistically obtained as measurement result. When recording states B0 and B1 are measured at phase time PA, a similar phenomenon occurs. When the measurement is performed at an incorrect phase time, the resultant information is probabilistically varied from the original information recorded by the recording person. The original information cannot be perfectly obtained from the probabilistically varied information by any mathematical operation, similarly to the first and second embodiments. Once reading with an incorrect reading key is performed, the original state cannot be obtained and another reading key cannot be tried, similarly to the first and second embodiments. Since the phase is selected so that a phase time at which all states are eigen-states does not occur, an incorrect reading result is produced even when the measurement is performed at any time. The perfect copy cannot be performed without reading, similarly to the first and second embodiments.

Safety equivalent to that in the third embodiment can be obtained in the fifth embodiment.

The reason why the safety in the fifth embodiment matches with that in the third embodiment because properties of the quantum state common to both a precessing spin and a coherently vibrating coupled quantum dot are used. Therefore, the same safety can be obtained also using another quantum state.

As the other state periodically transferring between an eigen-state and a superposition state, a molecular binding state is known. In the case of a molecule called tropolone shown in FIG. 22, two eigen-states exist at a hydrogen binding position and coherent oscillation occurs between the states. Therefore, when generation, retention, and reading of a specific phase can be performed in such as molecule, the cipher recording of the third embodiment can be performed using the oscillation phase.

(Case Using Many-Body System)

The first to fifth embodiments are methods of performing the present invention using a single quantum state such as a single spin or a single charge. The present invention can be performed using not only the single quantum state but also a quantum state group including a plurality of spins, charges, or molecule states.

Property of the quantum state group is firstly described, and possibility of performing the present invention using the property is then described.

(Quantum Ensemble)

A quantum ensemble is characterized by the type of the states forming the group and contents of the states. A quantum ensemble including only elements lying in the same quantum state is called a pure state, and a quantum ensemble including elements lying in different quantum states is called a mixed state. The mixed state is formed by mixing pure states. In the pure state, the state of the quantum ensemble can be specified by specifying only the quantum states of the elements. In the mixed state, the pure state included in the mixed state and the mixed ratio must be specified.

A group formed of ½ spins is taken as an example. The group where all spins point to the positive Z-axis direction lies in the pure state. The group where 70% of spins point to the positive Z-axis direction and 30% of spins point to the negative Z-axis direction lies in the mixed state.

(Batch Measurement)

When physical quantity in the quantum ensemble is measured in a lump, the measured result is the sum of individually measured elements constituting the quantum ensemble. Therefore, the measured value obtained for the quantum ensemble is determined by the measured values of the individual elements and the constituent ratios of the elements. In the mixed state, the measured value is derived by multiplying the measured value of each pure state constituting the mixed state by the constituent ratios and by summarizing the products.

(Eigen-State Element)

When an element of the group is an eigen-state with respect to the measurement, a determined value is returned definitely. For example, a spin element pointing to the positive Z-axis direction returns value +½. An element lying in the eigen-state keeps the original state even when the element is measured. Therefore, the group lying in the pure state including only eigen-states is kept in the pure state including only the same eigen-states after the measurement.

(Superposition State Element)

The quantum ensemble can include an element lying in superposition state. The superposition state is one of quantum states, so that the quantum ensemble in which all elements lie in the same superposition state lies in the pure state. When an element lying in the superposition state is measured, the element is irreversibly transferred to some eigen-state by the measurement. Therefore, when the pure state formed of the superposition states is measured, a mixed state formed by mixing pure states including only eigen-states is obtained. This state change is irreversible, and is similar to the phenomenon where the measurement of a quantum state formed of a single superposition state results in probabilistic and irreversible transfer to some eigen-state. In other words, once a group formed of the superposition states is measured, the state of the group changes irreversibly.

When a quantum state formed of a single superposition state is measured, the measured value and the state after the measurement can predicted only probabilistically. While, when the number of elements is large in a case of a quantum ensemble, the measured value and the state after the measurement can be predicted. For example, the pointing state to the positive X-axis direction is the superposition state of the pointing state to the positive Z-axis direction and the pointing state to the negative Z-axis direction, so that it cannot be definitely predicted whether the single spin turns to the positive Z-axis direction or to the negative Z-axis direction. While, when the group of only spins pointing to the positive X-axis direction is measured, half the spins turn to the positive Z-axis direction and the remaining half turn to the negative Z-axis direction. Therefore, even when it is not determined which direction each spin turns to, the following results can be definitely predicted. In other words, the measured value of the group is 0 because half the spins return +½ and the remaining half return −½. The state after the measurement is the mixed state equally including the pure state formed of the spins pointing to the positive Z-axis direction and the pure state formed of the spins pointing to the negative Z-axis direction.

(Operation to Group)

Unitary transformation can be applied to the quantum ensemble, similarly to the fact that a reversible operation, namely unitary transformation, can be applied to a single quantum state. When it is known which unitary transformation is applied to each element, a state of the group after the unitary transformation can be perfectly predicted. When the unitary transformation is applied to a pure state formed of a certain quantum state, a pure state formed of unitary-transformed elements is provided. When −90° rotation about the Y-axis is applied to the pure state formed of spins collectively pointing to the positive Z-axis direction, the pure state formed of spins collectively pointing to the positive X-axis direction is obtained. Regarding the unitary transformation applied to the quantum ensemble in a mixed state, the unitary transformation to the pure state constituting the mixed state is considered, and the mixed state of the pure state after the transformation is considered.

The unitary transformation to the quantum ensemble also causes only relative change, as the unitary transformation to a single quantum state causes only relative change from an original state. When a spin group is rotated, for example, relative change in direction can be predicted by the rotation received by each element. When the original state of the group cannot be specified, however, a state after the unitary transformation (rotation here) cannot be specified, either.

(Periodic Change)

A quantum ensemble including an element of which state periodically changes, for example a precessing spin and a coherently vibrating coupled quantum dot, also has a periodically changing state. This state change can be determined by considering the periodic state change of each element and recognizing the quantum ensemble as a group of the changing elements, similarly to the unitary transformation.

(Retention of State)

A quantum ensemble state is kept constant on an appropriate condition where each element does not change over time, similarly to the fact that a single quantum state is kept constant on an appropriate condition.

(No-Cloning Nature)

The copy of a quantum state in an unknown state is impossible, similarly to the fact that the copy of a single quantum state is impossible.

(Fully Mixed State)

In a system having only two eigen-states such as a ½ spin system, the mixed state equally including respective eigen-states is called a fully mixed state. For example, a group equally having spins pointing to the positive Z-axis direction and spins pointing to the negative Z-axis direction lies in the fully mixed state. When the Z-axis component of the fully mixed state is measured, the components in the positive and negative directions cancel out each other, and hence the measured value is 0. The component in an arbitrary direction except for Z-axis direction can be measured in the ½ spin system. However, the measured value by the measurement in an arbitrary direction is 0 in the fully mixed state, because each spin lies in a superposition state with respect to the measurement direction except for Z-axis direction. For example, the X-axis component is assumed to be measured. Both the spins pointing to the positive Z-axis direction and the spins pointing to the negative Z-axis direction lie in the superposition state that is formed of the pointing state to the positive X-axis direction and the pointing state to the negative X-axis direction. Therefore, all spins turn to the positive X-axis direction or to the negative X-axis direction at 50% probability, and return measurement result 0. This phenomenon occurs not only in the X-axis direction but also in the other arbitrary direction.

In the ½ spin system, groups formed of the same number of spins pointing to mutually opposite directions cannot be distinguished from each other regardless of the direction, and return 0 after the measurement to an arbitrary direction. This phenomenon is not changed by any unitary transformation (rotation).

(Vector Notation of Group)

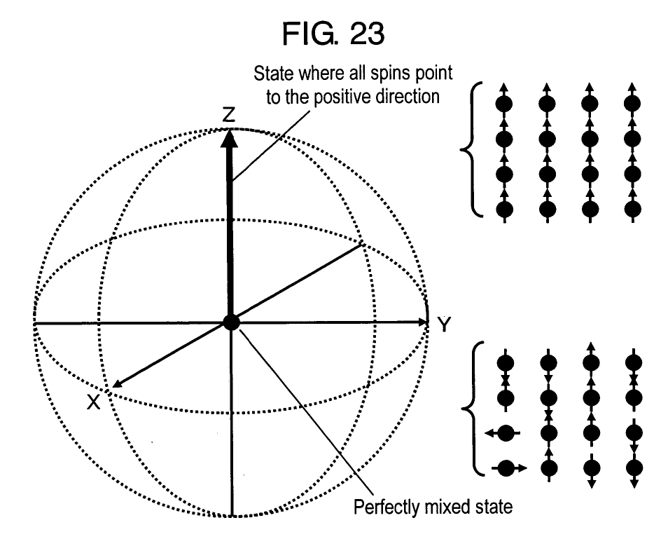

A state having the same number of pointing states to the positive X-axis direction and pointing states to the negative X-axis direction cannot be distinguished from a state having the same number of pointing states to the positive Y-axis direction and pointing states to the negative Y-axis direction. Similarly to this situation, states that are different in the microscopic view but cannot be distinguished in the macroscopic view are included in a quantum ensemble. In a system having only two eigen-states such as a ½ spin system, the state of the group can be represented using three real numbers. Three real numbers correspond to polarization of the spins of the group. The state of the quantum ensemble formed of ½ spins can be represented using a three-dimensional vector as shown in FIG. 23. The X, Y, and Z components of this vector are set as measured values by measurement in the X-axis, Y-axis, and Z-axis directions, respectively. A state of the group is hereinafter represented as (X component, Y component, Z component). Normalization is performed so that the measured value obtained when all spins point to a specific direction is 1.

In this representation, the pure state corresponds to a vector having length equal to 1, and the fully mixed state corresponds to a vector (origin) having length equal to 0. A state partially including a fully mixed state corresponds to a vector having length larger than 0 and smaller than 1. The direction of the vector indicates the polarization of the spin. In this representation, the unitary transformation of rotating each spin rotates the vector corresponding to this state by the same angle.

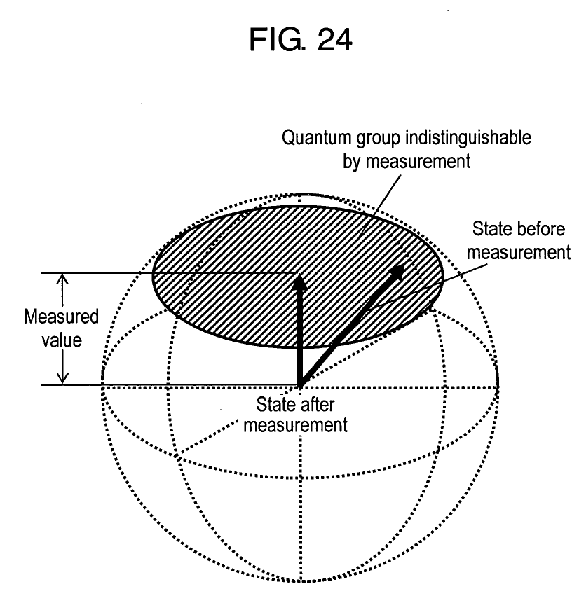

As shown in FIG. 24, the measurement of the group can be recognized as the projection of the vector onto the axis corresponding to a measuring direction. The length of the projected vector corresponds to a measured value, and the vector after the projection represents the group after the measurement. Therefore, all states that exist on the plane having a normal vector corresponding to the vector that represents the group after the measurement return the same measured value, become the same states after the measurement, and cannot be distinguished. Even two states that return the same measurement result with respect to a certain measurement direction can return different measurement results with respect to different measurement directions. The number of states returning the same measurement result is inevitably two or more, so that measurement allowing an arbitrary state to be distinguished does not exist.

### Sixth Embodiment

(Fundamental Elements of Recording Device for Performing Sixth Embodiment)

As a method of the sixth embodiment, the method of claim 4 of the present invention is described. Performing of the method of claim 4 requires the following elements:
a device for creating (initializing) a specific quantum ensemble state in response to information to be recorded and information called a reading key;
a quantum cipher recording medium for storing the quantum ensemble state;
a device for performing unitary transformation in response to the reading key information; and
a device for finally measuring the quantum ensemble state.

Various quantum ensembles are considered to be used, but a solid containing nuclides having ½ nuclear spin is described hereinafter.

(Nuclear Spin Group)

“Nuclear spin” means intrinsic angular momentum possessed by a particle (nucleus here), similarly to electron spin. The value of the nuclear spin depends on the nuclide of an atom. For example, 31P, 29Si, and 13C have ½ nuclear spin, so that they are suitable for the present embodiment. A solid composed of atoms having ½ nuclear spin and atoms (e.g. 28Si or 12C) having no nuclear spin, or liquid or gas composed of molecules (e.g. CF4) containing atoms having ½ nuclear spin can be used as a quantum ensemble of the present invention.

(Initialization of Nuclear Spin Group)

For putting a nuclear spin group into a specific state, similarly to a single spin, the spins are firstly polarized (initialized) in a certain direction, and are then turned to a desired direction by precession by a static magnetic field. The polarization of the spins is caused by applying a magnetic field, for example. During application of the magnetic field, the energy of the state where the spins are parallel with the magnetic field is lower than that of the state where the spins are not parallel with the magnetic field, so that parallel components increase. The polarization increases with decrease in temperature, so that the magnetic field may be applied in a state cooled by a cooling mechanism. When the polarization increases, the information can be retained for a long time. However, the cooling is not absolutely necessary differently from the single spin because the present invention does not require the formation of a perfectly polarized spin group state.

As described in the direction control section of the single spin, the initialization of the direction of the spins in this method requires a mechanism (energy dissipating mechanism) for flowing energy from the spins to the outside. The mechanism eliminates the initialization effect over time. In the present embodiment using the spin group, however, only the direction of the polarization is required to be retained, and the degree of polarization may vary over time as discussed later. In the three-dimensional vector notation, the length of the vector may be decreased as long as the direction thereof is retained. Generally, the energy dissipating mechanism decreases the degree of polarization of the spins but does not vary the direction of the polarization of the spins. The existence of the energy dissipating mechanism therefore does not essentially disturb the present embodiment. For retaining the information for a long time, a system that requires much time for initialization but dissipates small amount of energy is simply required.

An operation that cooling is performed only during recording and is not performed during retention may be selected.

(Rotation of Nuclear Spin Group)

For varying the direction of the polarization of the spin group, a static magnetic field is applied with the time and direction controlled. This is just the same as the case of the single spin.

(Measurement of Spin Direction Component)

The component in a certain direction of the spins of the spin group is measured using the energy difference caused by applying a magnetic field in the measuring direction. During application of the magnetic field, the energy of the state where the spins are parallel with the magnetic field is lower than that of the state where the spins are not parallel with the magnetic field, as discussed above. When the electromagnetic wave equivalent to the energy difference is emitted, the spins in the parallel state having lower energy absorb the electromagnetic wave and come into the nonparallel state. The absorption factor of the electromagnetic wave increases with increase in the number of the spins lying in the parallel state, so that the percentage of the parallel state, namely the component in the measurement direction, of the spins can be determined by measuring the absorption factor.

(Devices for Sixth Embodiment)

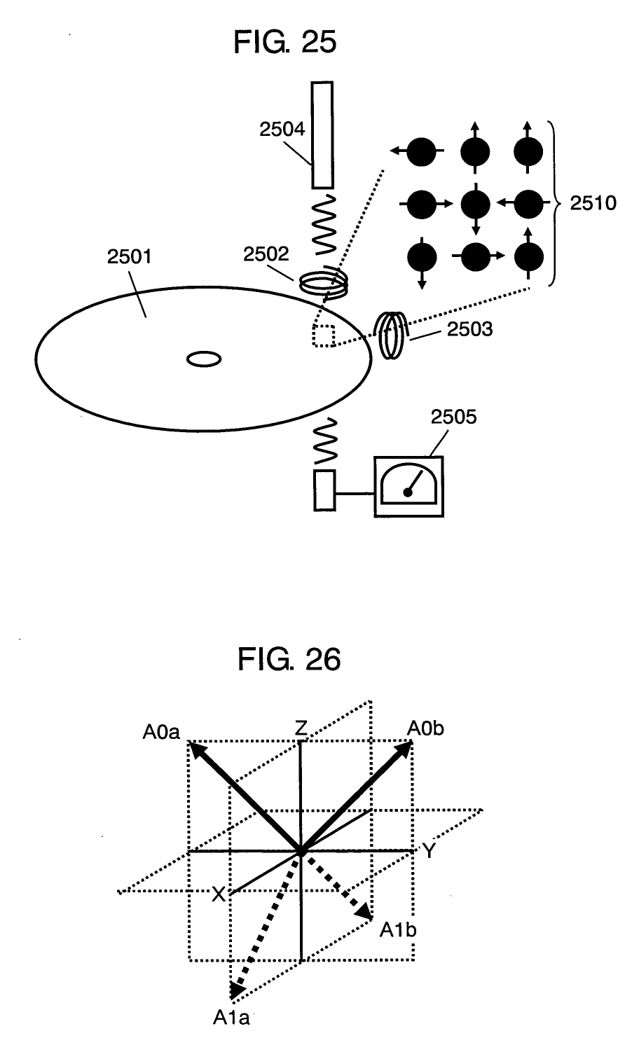

A configuration of the quantum cipher recording medium, the quantum cipher writing device, and the quantum cipher reading device in accordance with the sixth exemplary embodiment is shown in FIG. 25.

Quantum cipher recording medium 2501 has regions 2510 that are used for recording and include many atoms having ½ nuclear spin. The number of regions 2510 is equal to the number of bits of the information to be recorded. An example that the quantum ensemble used for recording the quantum cipher is formed in a part of a disk shape is described in FIG. 25, but the medium is not required to have the disk shape.

The quantum cipher writing device is formed of the following elements:
mechanism 2502 for locally applying a static magnetic field to generate the polarization of the spin group;
static magnetic field applying mechanism 2503 for turning the spin group to a required direction; and
a mechanism (not shown) for controlling them.

The quantum cipher decrypting device is formed of the following elements:
magnetic field applying mechanism 2503 for applying a static magnetic field to rotate the spins; and
a mechanism (not shown) for controlling it.

The quantum cipher reading device is formed of the following elements:
magnetic field applying mechanism 2502 for applying a magnetic field in the measuring direction;
mechanism 2504 for locally emitting resonance electromagnetic wave to a reading part;
mechanism 2505 for measuring the intensity of the electromagnetic wave having passed through a recording region and for measuring a spin component based on an absorption factor; and
a mechanism (not shown) for controlling them.

In the present embodiment, the quantum cipher writing device, the quantum cipher decrypting device, and the quantum cipher reading device are integrated, so that the static magnetic field applying mechanism is shared.

Inevitably, all devices including the quantum cipher recording medium may be integrated.

(Recording/Reproducing Method of Sixth Embodiment)

Recording and reproducing procedures of information using the quantum cipher recording device are described hereinafter.

(Recording)

An information recording person firstly prepares information to be recorded. It is assumed here that the information to be recorded is information derived by representing the text in “ ” of “This is a pen.” with ASCII code and by encrypting the text with key “KEY”, namely

| | | |
|---|---|---|
| 0011111 | 0101101 | 0110000 |
| 0111000 | 1100101 | 0110000 |
| 0111000 | 1100101 | 0111000 |
| 1101011 | 0110101 | 0111100 |
| 0100101 | 1101011 | 1111001. |

The information recording person prepares information that is called a reading key and is used for specifying a base for each bit and an algorithm for specifying the base, besides the information to be recorded, also in the present embodiment. The characteristics required of the reading key and the algorithm are similar to those in the first embodiment.

The recording person selects a quantum ensemble state to be created in each recording regions that are used for recording based on the information to be recorded and the base determined by the reading key and the algorithm.

The selecting method of the quantum ensemble state is set so as to satisfy the following condition. In other words, a person knowing the reading key performs the measurement after a correct decryption, and hence obtains a measured value corresponding to the recorded information. While, a person who does not know the reading key cannot perform the correct decryption, and cannot specify the recorded information based on the value obtained by the measurement in a state to which the correct decryption is not applied.

For example, this condition can be satisfied by the following operations:
one quantum state is taken from quantum states A0a and A0b in a random fashion when the information to be recorded is 0 and the base specified by the reading key is A;
one quantum state is taken from quantum states A1a and A1b in a random fashion when the information to be recorded is 1 and the base specified by the reading key is A;
one quantum state is taken from quantum states B0a and B0b in a random fashion when the information to be recorded is 0 and the base specified by the reading key is B; and
one quantum state is taken from quantum states B1a and B1b in a random fashion when the information to be recorded is 1 and the base specified by the reading key is B.
   This group of eight quantum states is set to satisfy the following conditions:

Condition 1: Whichever unitary transformation is performed, in measurement after the unitary transformation, there is no measured value range including only the state assigned to information 0 and no measured value range including only the state assigned to information 1;

Condition 2: Whichever unitary transformation is performed, in measurement after the unitary transformation, there is no measured value range including only the state assigned to base A and no measured value range including only the state assigned to base B; and

Condition 3: When the measurement is performed after a specific unitary transformation corresponding to the base, there are a measured value range including only the state assigned to information 0 and a measured value range including only the state assigned to information 1.

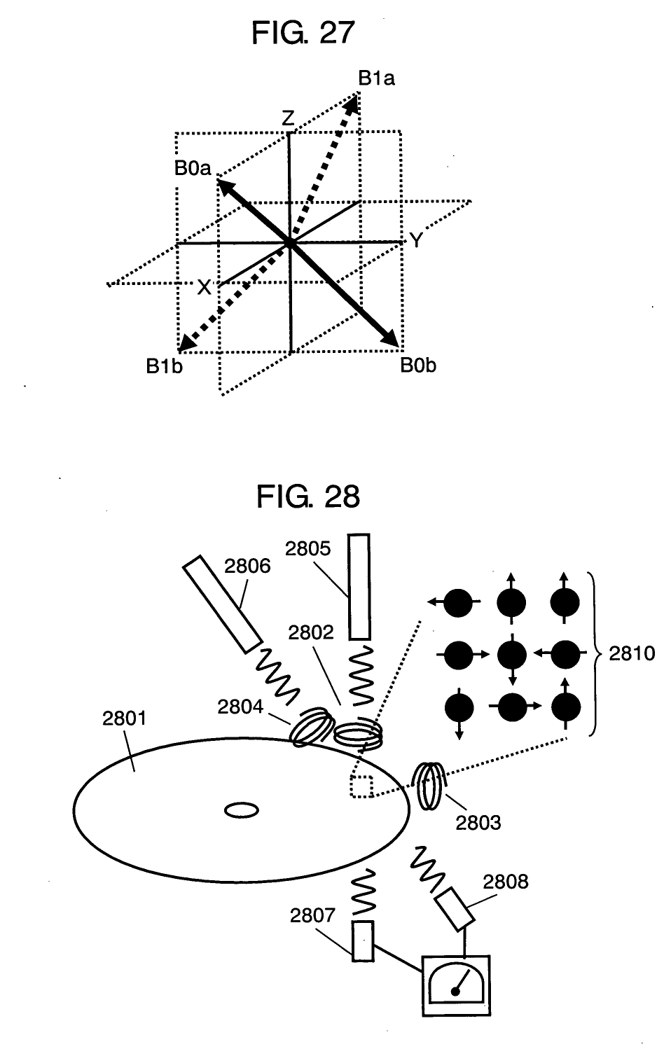

Examples of quantum states satisfying these conditions are represented as follows,
A0a=(0,−t,t)
A0b=(0,t,t)
A1a=(t,0,−t)
A1b=(−t,0,−t)
B0a=(t,0,t)
B0b=(0,t,−t)
B1a=(−t,0,t)
B1b=(0,−t,−t).
   These vectors are shown in FIG. 26 and FIG. 27. Here, “t” is 1/√2 or smaller and is larger than a minimum value allowing determination of positive or negative of the measured value without fault by reading. The recording person may freely select a value from this range and may select different value for each bit. The minimum value of “t” depends on the stored state and the accuracy of the reading device, so that the minimum value is previously determined by a reliability test or the like.

The fact that this state selection satisfies the above requirement will be described in the authorized read section and the unauthorized read section.

When one of A0a and A0b is selected in a random fashion, a selected result is not need to be recorded. This selection is inhibited from being unbalanced, and the selected result is inhibited from being leaked to an unauthorized information user.

The recording in A0a or A0b and A1a or A1b is hereinafter called the recording in base A, and the recording in B0a or B0b and B1a or B1b is called the recording in base B.

The quantum states specified from the information to be recorded and the reading key are represented as

| | |
|---|---|
| B0a, A0a, B1b, A1a, A1b, A1b, A1b | B0a, A1b, A0b, B1a, A1a, A0a, |
| | A1b |
| B0a, A1a, B1a, B0b, A0b, A0b, B0a | B0b, A1a, B1a, A1b, A0a, A0b, |
| | A0a |
| B1b, A1a, A0a, B0a, A1b, A0a, A1b | B0a, A1a, B1a, B0b, A0b, A0a, |
| | B0b |
| B0a, A1a, B1b, A1a, A0a, A0a, A0b | B1a, A1a, A0a, B0b, A1b, A0a, |
| | A1b |
| B0a, A1a, B1a, B1b, A0b, A0a, B0a | B1a, A1b, B0a, A1b, A0a, A1a, |
| | A1a |
| B0a, A1a, A1b, B0a, A1b, A0b, A1a | B0a, A1a, B1a, B1b, A1a, A0a, |
| | B0a |
| B0b, A1a, B0a, A0a, A1b, A0a, A1a | B1b, A1a, A0a, B1b, A0a, A1b, |
| | A1a |
| B1a, A1b, B1b, B1a, A0a, A0a, B1a. | |

Here, “a” and “b” are selected in a random fashion.

(Write)

The selected quantum ensemble state is created in the quantum recording medium using the quantum cipher writing device. In the present embodiment, the spins are firstly polarized by applying a high magnetic field to recording region 2510 of quantum cipher recording medium 2501 using coil 2502. A procession of a desired angle is then caused by applying another magnetic field with the direction and time controlled using another magnetic coil 2503, and the nuclear spin group is put into the selected quantum ensemble state. When many quantum ensembles for recording are formed in the same board, a magnetic field can be difficult to be applied only to a specific quantum ensemble. In this case, a quantity where a magnetic field applied for writing into a certain part changes the other part is previously measured, and a corrective magnetic field having different position and intensity is applied using the coil so as to cancel the change.

(Retention)

The quantum ensemble state formed in the quantum cipher recording medium is retained until reading. Value “t” in the representation of the group state may vary in a range of 1/√2 or smaller to a value larger than the minimum value allowing determination of positive or negative of the measured value without fault by reading. Value “t” generally decreases over time, so that the guaranteeing time period of the information retention is determined based on the reading limit. The recording person delivers the recording medium holding the state and the reading key to the authorized information user.

(Decryption)

The authorized information user applies a decryption operation to the quantum cipher recording medium with the quantum cipher decrypting device, similarly to the first embodiment. The decryption operation is a transformation of the state of the information recorded by the measurement to a certainly read state. This operation corresponds to the unitary transformation of dividing the states assigned to information 0 and the states assigned to information 1 into two groups distinguishable by measurement.

This decryption can be realized by applying no rotation to base A of eight quantum states and applying 45° rotation about X-axis, −90° rotation about Y-axis, and −45° rotation about Z-axis to base B for eight states described above. This operation can be realized by applying a magnetic field to each nuclear group with the intensity, direction, and time controlled using coils 2502 and 2503.

This rotation transforms eight quantum states to the following states,
A0a′=(0, −t, t)
A0b′=(0, t, t)
A1a′=(t, 0, −t)
A1a′=(t, 0, t)
B1a′=((1−√2)t/2, (1−√2)t/4, √2t/2)
B0a′=((−1+√2)t/2, (1+√2)t/4, √2t/2)
B0a′=((−1−√2)t/2, (−1−√2)t/4, −√2t/2)
B0a′=((1+√2)t/2, (−1+√2)t/4, −√2t/2),
   respectively.

(Read)

After the system is decrypted, the authorized information user measures the quantum cipher recording medium with the quantum cipher recording device. In the present embodiment, a resonance electromagnetic wave is emitted using electromagnetic wave emitting mechanism 2504 while a magnetic field is applied in the Z-axis direction by magnetic field coil 2502, the intensity of the electromagnetic wave having passed through the medium is measured by measuring mechanism 2505, the absorption factor is determined based on the intensity, and the Z-component of the spin group is determined. After the correct decryption, the Z-component of the quantum ensemble assigned to information 0 is t or √2t/2, namely a negative value, and the Z-component of the quantum ensemble assigned to information 1 is −t or −√2t/2, namely a positive value. Therefore, the information recorded by the recording person can be certainly read, because the information is judged to be 0 when the measurement result of the Z-component is positive, or 1 when the measurement result of the Z-component is negative. Of three conditions discussed above, Condition 3 is satisfied. When this decryption and reading are performed, decryption is then performed using cipher key “KEY” of the mathematical cipher, and the interpretation is performed according to the ASCII code table, the authorized information user can obtain the information intended to be sent by the recording person.

Thus, the quantum cipher recording device of the present invention also allows the authorized information user to obtain correct information.

(Unauthorized Read)

The unauthorized decryption by an unauthorized information user is described hereinafter. It is assumed that the unauthorized information user can obtain a quantum cipher recording medium where information is recorded, but does not know the reading key or the mathematical cipher key. The processes until retention of information are the same as those of the authorized use of the information, so that the description of the processes is omitted.

Since the unauthorized information user does not know the reading key, the user cannot specify the base and hence cannot specify a correct decryption to be applied to each reading quantum ensemble. Only the measurement after a random unitary transformation for decryption is allowed. When an incorrect unitary transformation for decryption is performed and the measurement is then performed, the recorded information is damaged and probabilistically different result is produced.

When the decryption of base A is applied to the recorded states, for example, the states after the decryption are represented as
A0a′=(0,−t,t)
A0b′=(0,t,t)
A1a′=(t,0,−t)
A1a′=(t,0,t)
B0a′=(t,1,t)
B0b′=(0,t,−t)
B1a′=(−t,0,t)
B1b′=(0,−t,−t).
   When these states are measured, measurement result +t is obtained in A0a′, +t in A0b′, −t in A1a′, −t in A1b′, +t in B0a′, −t in B0b′, +t in B1a′, and −t in B1b′. In other words, even when measurement result +t is obtained, the state before the measurement is A0a′, A0b′, B0a′, or B1a′, and hence cannot be distinguished. It cannot be judged whether the recorded information is 0 or 1.

The states after the decryption are represented as
A0a″=(0,0,t)
A0b″=(0,0,t)
A1a″=(0,0,−t)
A1b″=(0,0,−t)
B0a″=(0,0,t)
B0b″=(0,0,−t)
B1a″=(0,0,t)
B1b″=(0,0,−t).
   The original states of which measurement result is +t are four states A0a, A0b, B0a and B1a, and cannot be distinguished from each other. Therefore, the original state cannot be reproduced after the measurement. The reading key cannot be retrieved by re-measurement.

The information cannot be read, namely Condition 1 and Condition 2 are satisfied, even by a method other method than decryptions UA and UB. This can be confirmed by the following phenomena.

The measurement result of the quantum ensemble is a projected component on the axis in the measurement direction as shown in FIG. 24, and states lying on the plane projected on the same point cannot be distinguished from each other. Since the axis in the measurement direction is fixed to the Z-axis direction in the present embodiment, the states represented as a point on the plane having the Z-axis as the normal cannot be distinguished from each other. However, the measurement can be performed after an arbitrary unitary transformation. Unitary transformations correspond to rotations of vectors, so that states indistinguishable when a certain unitary transformation is selected for measurement are states existing on the plane of which normal is a certain axis. The selected unitary transformation corresponds to the rotation where the normal is Z-axis.

An arbitrary unitary transformation can be performed, but the state is projected irreversibly by one measurement. Therefore, for distinguishing the states by measurement, the unitary transformation that projects the states to be distinguished on different points must be appropriately performed.

Since “t” has flexibility in eight states discussed above, distinguishing any two states in eight states requires that the Z-component of one group is positive and the Z-component of the other group is negative. Conversely, the measurement allows distinguishment only between a group having positive Z-component and a group having negative Z-component. Even when an arbitrary unitary transformation is assumed performable, only states existing on separate sides of half spaces partitioned by the plane passing the origin are distinguishable from each other. The rotation where the normal of the plane matches with the Z-axis corresponds to the unitary transformation.

In the case of eight groups, however, the state assigned to 0 and the state assigned to 1 exist in respective spaces partitioned even in any plane passing the origin, and the state assigned to base A and the state assigned to base B exist in the spaces. In other words, whichever unitary transformation is performed, there is no measured value including only the state assigned to only specific information and a specific base. In other words, Condition 1 and Condition 2 are satisfied. When these conditions are satisfied, the recorded information and base cannot be specified by any measurement, and the safety of the information is guaranteed.

The quantum ensemble state cannot be copied, so that unauthorized copy of it cannot be performed by an unauthorized information user.

Safe information recording can be performed by the method using the quantum ensemble similarly to the first embodiment.

### Seventh Embodiment

(Fundamental Elements of Recording Device for Performing Seventh Embodiment)

As a method of the seventh embodiment, the method of claim 5 of the present invention is described. Performing of the method of claim 5 requires the following elements:
a quantum cipher writing device for creating a specific quantum ensemble state having two or more incompatible physical quantities in response to information to be recorded and information called a reading key;
a quantum cipher recording medium for storing the quantum ensemble state; and
a quantum cipher reading device for selecting a physical quantity and measuring the quantum ensemble state.

When a nuclear spin group is used as the quantum ensemble, the writing corresponds to determining the polarization of the nuclear spin, and the specifying of the measuring direction and measuring of the state corresponds to selecting and measuring a physical quantity.

These devices can be realized by various methods. A method using a solid containing nuclides having ½ nuclear spin is described hereinafter.

(Devices for Seventh Embodiment)

A configuration of the quantum cipher recording medium, the quantum cipher writing device, and the quantum cipher reading device in accordance with the seventh exemplary embodiment is shown in FIG. 28.

Quantum cipher recording medium 2801 has regions 2810 that are used for recording and include many atoms having ½ nuclear spin such as 13C and 29Si. The number of the regions is equal to the number of bits of the information to be recorded.

The quantum cipher writing device is formed of the following elements:
mechanism 2802 for locally applying a static magnetic field to generate the polarization of the spin group;
static magnetic field applying mechanism 2803 for turning the spin group to a required direction; and
a mechanism (not shown) for controlling them.

The quantum cipher reading device is formed of the following elements:
magnetic field applying mechanism 2802 for locally applying a static magnetic field in a first measuring direction to a measured part;
magnetic field applying mechanism 2804 for locally applying a static magnetic field in a second measuring direction to the measured part;
mechanism 2805 for locally emitting a resonance electromagnetic wave in the first measuring direction to a read part;
mechanism 2806 for locally emitting a resonance electromagnetic wave in the second measuring direction to the read part;
mechanism 2807 for measuring the intensity of the electromagnetic wave having passed through a recording region to measure the component in the first measuring direction, and for measuring the spin component based on an absorption factor; and
mechanism 2808 for measuring the intensity of the electromagnetic wave having passed through the recording region to measure the component in the second measuring direction, and for measuring the spin component based on the absorption factor.

In the case of using the spin group, the quantum cipher writing device and the quantum cipher recording medium similar to those of the sixth embodiment can be used. The quantum cipher reading device must specify the direction and measure the spin group, differently from the sixth embodiment. This can be realized by keeping the direction of the applied static magnetic field to be controllable.

A case where the recording medium, the writing device, and the reading device are separated from each other is described in the present embodiment; however, they may be integrated.

(Recording/Reproducing Method of Seventh Embodiment)

Recording and reproducing procedures of information using the quantum cipher recording device are described hereinafter.

(Recording)

An information recording person firstly prepares information to be recorded. The information recording person prepares information that is called a reading key and is used for specifying a base for each bit and an algorithm for specifying the base, besides the information to be recorded. The characteristics required of the reading key and the algorithm are similar to those in the other embodiments.

The recording person selects a quantum ensemble state to be created in the quantum cipher recording medium, based on the information to be recorded and the base that is determined from the reading key and the algorithm.

The selecting method of the quantum ensemble state is set so as to satisfy the following condition. In other words, when a correct physical quantity corresponding to the base is measured, a measured value corresponding to the recorded information is obtained. While, when an incorrect physical quantity is measured, the recorded information cannot be specified based on the obtained value.

For example, this condition can be satisfied by the following operations:
one quantum state is taken from quantum states A0a and A0b in a random fashion when the information to be recorded is 0 and the reading key is 0;
one quantum state is taken from quantum states A1a and A1b in a random fashion when the information to be recorded is 1 and the reading key is 0;
one quantum state is taken from quantum states B0a and B0b in a random fashion when the information to be recorded is 0 and the reading key is 1; and
one quantum state is taken from quantum states B1a and B1b in a random fashion when the information to be recorded is 1 and the reading key is 1.
   This group of eight quantum states is set to satisfy the following conditions:

Condition 1: Whichever physical quantity is measured, there is no measured value range including only the state assigned to information 0 and no measured value range including only the state assigned to information 1;

Condition 2: Whichever physical quantity is measured, there is no measured value range including only the state assigned to base A and no measured value range including only the state assigned to base B; and

Condition 3: When the physical quantity corresponding to the base is measured, there are a measured value range including only the state assigned to information 0 and a measured value range including only the state assigned to information 1.

Examples of quantum states satisfying these conditions are represented as follows,
A0a=(0,−t,t)
A0b=(0,t,t)
A1a=(t,0,−t)
A1b=(−t,0,−t)
B0a=(t,0,t)
B0b=(0,t,−t)
B1a=(−t,0,t)
B1b=(0,−t,−t).
   These eight states are the same as those in the sixth embodiment. The fact that these states satisfy the three conditions will be described in the authorized read section and the unauthorized read section.

(Write)

The selected quantum ensemble state is created in the quantum recording medium by the quantum cipher writing device. The spins are polarized by applying a magnetic field using coil 2802, a magnetic field generated by coil 2803 is further added to generate a precession, thereby creating a desired state.

(Retention)

This quantum ensemble state is retained until reading. Value “t” in the representation of the group state may vary in a range of 1/√2 or smaller to a value larger than a minimum value allowing determination of positive or negative of the measured value without fault by reading.

(Read)

In the seventh embodiment, similarly to the second embodiment, decryption is not performed and a physical quantity to be measured is selected in response to the base determined according to the reading key and a base determining algorithm. In this embodiment, selecting the measuring direction of the spin corresponds to selecting a physical quantity. The authorized information user knows the reading key, so that the user can specify the base of each bit and hence can specify a physical quantity to be measured in each bit. In other words, physical quantity A is measured for base A, and physical quantity B is measured for base B. Here, physical quantity A is the component in the Z-axis direction and physical quantity B is the component in the direction parallel with vector (1,1,0). In the present embodiment, the magnetic field applying mechanism for measurement, the electromagnetic wave emitting mechanism, and the electromagnetic wave intensity measuring mechanism are prepared in each direction. After the measuring direction is determined, the magnetic field applying mechanism applies the magnetic field in the measuring direction, the electromagnetic wave emitting mechanism emits the electromagnetic wave in this direction, and the measuring mechanism measures the electromagnetic wave absorption factor of the medium.

At this time, measurement result t (>0) is obtained when states A0a and A0b are measured (MA), and measurement result −t (<0) is obtained when states A1a and A1b are measured (MA).

Similarly, measurement result t/√2 (>0) is obtained when states B0a and B0b are measured (MB), and measurement result −t/√2 (<0) is obtained when states B0a and B0b are measured (MB).

When a correct physical quantity is selected and measured, the measured value of a quantum ensemble assigned to information 0 is positive, and the measured value of a quantum ensemble assigned to information 1 is negative. The information recorded by the recording person can be certainly read, because the information is judged to be 0 when the measurement result is positive, or 1 when the measurement result is negative. Therefore, when the decryption is performed using the cipher key of the mathematical cipher, the authorized information user can obtain the information intended to be sent by the recording person.

The correct information can be transmitted to the authorized information user also by the quantum cipher recording device of the present invention.

(Unauthorized Read)

The unauthorized decryption by an unauthorized information user is described hereinafter. It is assumed that the unauthorized information user can obtain a medium where information is recorded, but does not know the reading key or the mathematical cipher key. The processes until retention of information are the same as those of the authorized use of the information, so that the description of the processes is omitted.

Since the unauthorized information user does not know the reading key, the user cannot specify the correct physical quantity to be measured for each quantum ensemble. Only a random physical quantity can be selected and measured.

The measurement result of the quantum ensemble is a projected component on the axis in the measurement direction as shown in FIG. 24, and states lying on the plane projected on the same point cannot be distinguished from each other. Since “t” has flexibility in eight states discussed above, distinguishing any two states in eight states requires that the projected component of one group is positive and the projected component of the other group is negative. Conversely, the measurement allows distinguishment only between quantum ensembles existing on the opposite sides of the space partitioned by the plane that has a normal as the measuring axis and passes through the origin.

In the case of eight groups, however, both the state assigned to 0 and the state assigned to 1 exist in respective spaces partitioned in any plane passing through the origin, and the state assigned to base A and the state assigned to base B exist in the spaces. In other words, when the measurement in any direction is performed, there is no measured value including only the state assigned to only specific information and a specific base. In other words, Condition 1 and Condition 2 are satisfied. When these conditions are satisfied, the recorded information and base cannot be specified by any measurement, and the safety of the information is guaranteed.

In other words, the unauthorized information user who does not know the reading key as information for specifying the base used for each bit cannot correctly read the recorded information whichever measurement is performed. According to the characteristic of the quantum ensemble, once reading is performed using an incorrect reading key, the original state cannot be obtained and another reading key cannot be tried. A perfect copy cannot be performed without reading, either.

In the seventh embodiment, safety similar to that in the second embodiment can be obtained.

### Eighth Embodiment

(Fundamental Elements of Recording Device for Performing Eighth Embodiment)

As a method of the eighth embodiment, the method of claim 6 of the present invention is described. Performing of the method of claim 6 requires the following elements:
a quantum cipher writing device for creating a specific state and phase of a quantum ensemble that periodically varies in state in response to information to be recorded and information called a reading key;
a quantum cipher recording medium for storing the state and phase; and
a quantum cipher reading device for selecting a phase time and measuring the quantum ensemble state.

When a nuclear spin group is used as the quantum ensemble, the writing corresponds to creating of a state having a specific polarization at a certain time, and the quantum cipher recording medium is required to rotate the polarized state with the phase kept.

These devices can be realized by various methods. A method using a solid containing nuclides having ½ nuclear spin is described hereinafter.

(Devices for Eighth Embodiment)

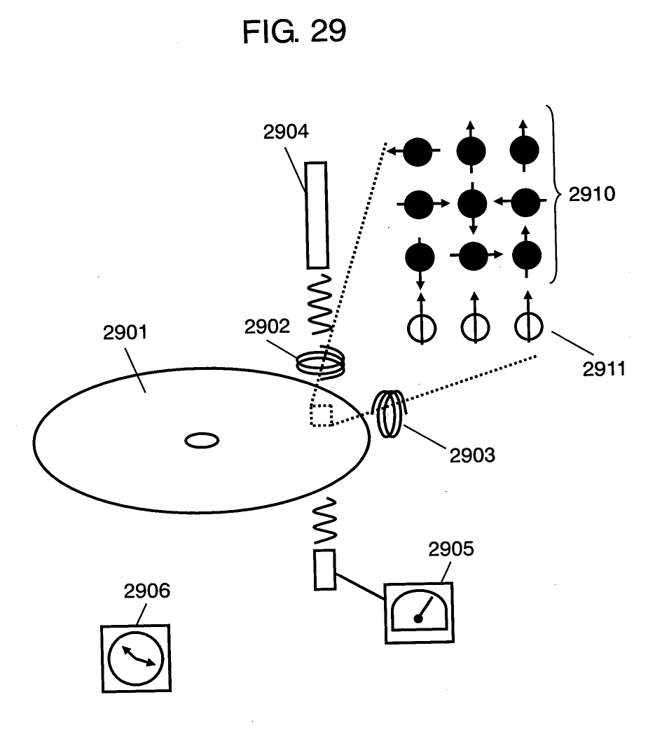

A configuration of the quantum cipher recording medium, the quantum cipher writing device, and the quantum cipher reading device in accordance with the eighth exemplary embodiment is shown in FIG. 29.

Quantum cipher recording medium 2901 has regions 2910 that are used for recording and include many atoms having ½ nuclear spin. The number of the regions is equal to the number of bits of the information to be recorded. Magnetic field generating mechanism (e.g. ferromagnetic layer) 2911 for supplying a magnetic field for causing a steady precession in the nuclear spins is formed near the medium, and is magnetized.

The quantum cipher writing device is formed of the following elements:
magnetic field applying mechanism 2902 for locally applying a static magnetic field to generate the polarization of the spin group;
magnetic field applying mechanism 2903 for turning the spin group to a required direction; and
a mechanism (not shown) for controlling them.

The quantum cipher reading device is formed of the following elements:
magnetic field applying mechanism 2902 for locally applying a static magnetic field in a measuring direction to a read part;
mechanism 2904 for locally emitting a resonance electromagnetic wave to a read part;
mechanism 2905 for measuring the intensity of the electromagnetic wave having passed through a recording region and measuring the spin component based on an absorption factor; and
a mechanism (not shown) for controlling them.

Additionally, clock circuit 2906 for operating the quantum cipher writing device and the quantum cipher reading device while the phase time is controlled are required.

This configuration is similar to those of the sixth and seventh embodiments. However, the quantum cipher recording medium of the present embodiment is required to cause periodic variation while the phase of the quantum ensemble is kept. This can be performed by continuously applying a constant static magnetic field to the quantum ensemble, similarly to the third embodiment.

A case where the writing device and the reading device are integrated and the recording medium is separated from the devices is described in the present embodiment; however, they may be integrated.

(Recording/Reproducing Method of Eighth Embodiment)

Recording and reproducing procedures of information using the quantum cipher recording device are described hereinafter.

(Recording)

An information recording person firstly prepares information to be recorded. It is preferable that the information to be recorded is previously mathematically encrypted, but it is not indispensable. The recording person prepares information that is called a reading key and is used for specifying a base for each bit and an algorithm for specifying the base, besides the information to be recorded, similarly to the other embodiments. The characteristics required of the reading key and the algorithm are also similar to those in the other embodiments.

The recording person selects a quantum ensemble state to be created in each recording regions that are used for recording based on the information to be recorded and the base determined by the reading key and the algorithm.

The selecting method of the quantum ensemble state is set so as to satisfy the following condition. In other words, when a measurement is performed at a correct phase time determined by the base, a measured value corresponding to the recorded information is obtained. While, when the measurement is performed at an incorrect phase time, the recorded information cannot be specified based on the measured value.

For example, this condition can be satisfied by the following operations:
one quantum state is taken from quantum states A0a and A0b in a random fashion when the information to be recorded is 0 and the base specified by the reading key is A;
one quantum state is taken from quantum states A1a and A1b in a random fashion when the information to be recorded is 1 and the base specified by the reading key is A;
one quantum state is taken from quantum states B0a and B0b in a random fashion when the information to be recorded is 0 and the base specified by the reading key is B; and
one quantum state is taken from quantum states B1a and B1b in a random fashion when the information to be recorded is 1 and the base specified by the reading key is B.
   This set of eight quantum states is set to satisfy the following conditions:

Condition 1: At an arbitrary phase time, either of a region in which measured value is inevitably positive and a region in which measured value is inevitably negative can include states assigned to 0 and 1;

Condition 2: At an arbitrary phase time, either of a region in which measured value is inevitably positive and a region in which measured value is inevitably negative can include states assigned to bases A and B; and

Condition 3: When a base is specified, a phase time period when one of a region where measured value is positive and a region where measured value is negative includes only the state assigned to 0 and the other includes only the state assigned to 1 inevitably exits.

An example of the set of quantum states satisfying these conditions are represented at time t0 as follows,
A0a=(0,−t,t)
A0b=(0,t,t)
A1a=(t,0,−t)
A1b=(−t,0,−t)
B0a=(t,0,t)
B0b=(0,t,−t)
B1a=(−t,0,t)
B1b=(0,−t,−t).
   This group rotates about axis (1,−1,0) at period T. Here, “t” is set in a range of 1/√2 or smaller to a value larger than the minimum value allowing determination of positive or negative based on the accuracy of the reading device.

The fact that these eight states satisfy the three conditions will be described in the authorized read section and the unauthorized read section.

(Write)

A recording person sets the nuclear spin group in the quantum recording medium to be the selected quantum ensemble state with the quantum cipher writing device. A fundamental method is similar to those of the sixth and seventh embodiments. The spins are polarized by applying a magnetic field using magnetic field applying mechanism 2902, and are turned to a desired direction using rotating mechanism of magnetic field applying mechanism 2903. In the present embodiment, magnetic field generating mechanism 2911 for generating a periodic motion during retention exists differently from the sixth and seventh embodiments, and generates a periodic motion. A state to be created by writing is a periodic motion state having a specific period, so that the magnetic fields are applied by magnetic field applying mechanisms (e.g. coils) 2902 and 2903 so as to provide a desired phase by controlling the length of the applying time period and applying timing. This time control is performed by clock circuit 2906. A procession has angular velocity increasing with increase in intensity of applied magnetic field, so that the desired phase may be obtained by adjusting the intensities of the magnetic fields applied by magnetic field applying mechanisms (e.g. coils) 2902 and 2903.

(Retention)

This quantum ensemble state is retained until reading. A periodic state variation is continued at a constant period with the phase kept. Value “t” in the representation of the group state may vary in a range of 1/√2 or smaller to a value larger than a minimum value allowing determination of positive or negative of the measured value without fault by reading.

(Read)

The authorized information user specifies the base of each bit according to the information of the disclosed reading key, and measures the state of the quantum cipher recording medium at a correct phase time according to the base using the quantum cipher reading device. In the present embodiment, using clock circuit 2906, a magnetic field is applied at a specified phase time using magnetic field applying mechanism (coil) 2902, an electromagnetic wave is emitted using electromagnetic wave emitting mechanism 2904, an absorption factor is determined by measuring the intensity using measuring mechanism 2905, and recording region 2910 is measured.

A correct phase time can be determined as follows when the used base is obvious.

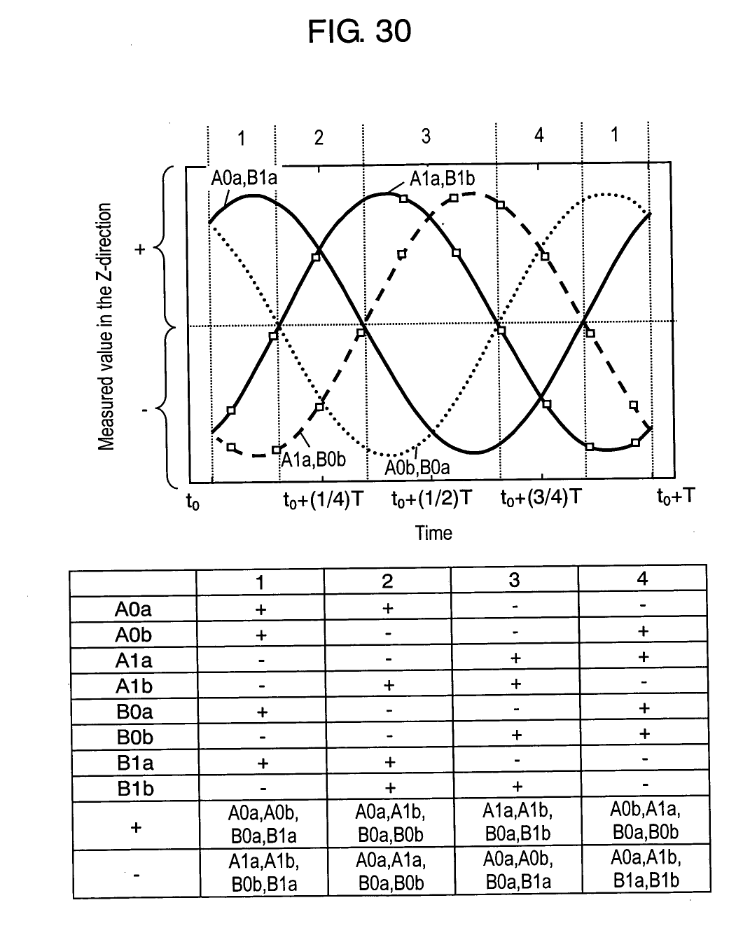

A value measured at each phase time is shown in FIG. 30.

In the case of eight states, 0 {A0a,A0b} of base A is + and 1 {A1a,A1b} of base A is—when the measurement is performed in phase time period 1, so that information recorded in base A can be read. Similarly, information recorded in base B can be read in phase time period 2. In phase time period 3, assignment of + and − to 0 and 1 is inverted from that in phase time period 1, but the information in base A can be read. In phase time period 4, assignment of + and − to 0 and 1 is inverted from that in phase time period 2, but the information in base B can be read.

The authorized information user knows the reading key, so that the user can specify whether each bit is recorded in base A or base B. The recorded information can be correctly read by reading the bit recorded in base A in phase time period 1, reading the bit recorded in base B in phase time period 2, judging the information as 0 when + is obtained, and judging the information as 1 when − is obtained. The recorded information may be read by reading the bit recorded in base A in phase time period 3, reading the bit recorded in base B in phase time period 4, judging the information as 1 when + is obtained, and judging the information as 0 when − is obtained.

When reading is performed in a correct phase time period specified by the reading key and judgement by correct association with the information is performed, the authorized information user can correctly read the recorded information.

(Unauthorized Read)

The unauthorized decryption by an unauthorized information user is described hereinafter. It is assumed that the unauthorized information user can obtain a medium where information is recorded, but does not know the reading key or the mathematical cipher key. The processes until retention of information are the same as those of the authorized use of the information, so that the description of the processes is omitted.

Since the unauthorized information user does not know the reading key, the user cannot specify the correct phase time at which each quantum ensemble is to be measured. Only a random phase time can be selected for measurement.

As shown in FIG. 30, however, when eight quantum ensembles used for recording information is measured in any of phase time periods 1 to 4, a state assigned to information 0, a state assigned to information 1, a state using base A, and a state using base B exist in both the group having positive measured value and the group having negative measured value. In other words, whenever the measurement is performed, the recorded information and the base cannot be specified based on the measurement result. Conditions 1 and 2 discussed above are thus satisfied. When Conditions 1 and 2 are satisfied, the unauthorized information user who does not know the reading key as information for specifying the base used for each bit cannot correctly read the recorded information whichever phase time measurement is performed at.

According to the characteristic of the quantum ensemble, once reading is performed using an incorrect reading key, the original state cannot be obtained and another reading key cannot be tried. A perfect copy cannot be performed without reading, either.

In the eighth embodiment, safety similar to the other embodiments can be obtained.

The spin group is used in the eighth embodiment; however, a group of which each element varies periodically between an eigen-state and a superposition state may be used. For example, a group formed of coupled quantum dots having the same structure or a group formed of molecules such as tropolone periodically varying in state may be used.

The cipher recording technology of the present invention can be used for recording the information that is not intended to be disclosed to an unauthorized information user. This information is, for example, personal information such as electronic money, credit card information, residenter information, or electronic passport.

What is claimed is:

1. A recording/reproducing method of information comprising:
a first step of preparing:
information to be recorded;
wherein a person who knows the information can specify a base used for recording each bit and a person who does not know the information cannot specify the base; and
an algorithm for determining the base of each bit from the reading key;
a second step of selecting a state to be created in each bit from a set of quantum states selected so as to satisfy the following condition:
the quantum states are transformed into eigen-states having a measured value corresponding to the information to be recorded when the unitary transformation corresponding to each base is performed; but
the quantum states are transformed into at least one superposition state when the unitary transformation corresponding to a different base is performed,
wherein the selection is performed based on the information to be recorded prepared in the first step and the base determined from the reading key and the algorithm;
a third step of creating the quantum state selected in the second step on a recording medium;
a fourth step of storing the quantum state created in the third step on the recording medium;
a fifth step of delivering the recording medium storing the quantum state of the fourth step to an authorized information user and disclosing the reading key and the algorithm for determining the base from the reading key;
a sixth step of determining the base of each bit from the disclosed reading key and the algorithm for determining the base, and performing the unitary transformation corresponding to the base to transform the quantum state to an eigen-state; and
a seventh step of measuring the quantum state transformed to an eigen-state and obtaining a measurement result corresponding to the recorded information.

2. A recording/reproducing method of information comprising:
a first step of preparing:
information to be recorded;
information that is called a reading key,
wherein a person who knows the information can specify a base used for recording each bit and a person who does not know the information cannot specify the base; and
an algorithm for determining the base of each bit from the reading key;
a second step of selecting a state to be created in each bit from a set of quantum states selected so as to satisfy the following condition:
the quantum states are transformed into eigen-states having a measured value corresponding to the information to be recorded when a physical quantity corresponding to each base is measured; but
the quantum states are transformed into superposition states when a physical quantity corresponding to a different base is measured,
wherein the selection is performed based on the information to be recorded prepared in the first step and the base determined from the reading key and the algorithm;
a third step of creating the quantum state selected in the second step on a recording medium;
a fourth step of storing the quantum state created in the third step on the recording medium;
a fifth step of delivering the recording medium storing the quantum state of the fourth step to an authorized information user and disclosing the reading key and the algorithm for determining the base from the reading key; and
a sixth step of determining the base of each bit from the disclosed reading key and the algorithm for determining the base, measuring the physical quantity corresponding to the base, and producing a measurement result corresponding to the recorded information.

3. A recording/reproducing method of information comprising:
a first step of preparing:
information to be recorded;
information that is called a reading key,
wherein a person who knows the information can specify a base used for recording each bit and a person who does not know the information cannot specify the base; and
an algorithm for determining the base of each bit from the reading key;
a second step of selecting a phase state to be created in each bit from a set of phases of quantum states periodically varying so as to satisfy the following condition:
the quantum states are transformed into eigen-states having a measured value corresponding to the information to be recorded at a measurement phase time corresponding to each base; but
the quantum states are transformed into superposition states at a phase time corresponding to a different base,
wherein the selection is performed based on the information to be recorded prepared in the first step and the base determined from the reading key and the algorithm;
a third step of creating the quantum state selected in the second step on a recording medium;
a fourth step of storing the quantum state created in the third step on the recording medium;
a fifth step of delivering the recording medium storing the quantum state of the fourth step to an authorized information user and disclosing the reading key and the algorithm for determining the base from the reading key; and
a sixth step of determining the base of each bit from the reading key, measuring a physical quantity at the phase time corresponding to the base, and producing a measurement result corresponding to the recorded information.

4. A recording/reproducing method of information comprising:
a first step of preparing:
information to be recorded;
information that is called a reading key,
wherein a person who knows the information can specify a base used for recording each bit and a person who does not know the information cannot specify the base; and
an algorithm for determining the base of each bit from the reading key;
a second step of selecting a quantum ensemble state to be created in each bit from a set of quantum states selected so as to satisfy three following conditions:
Condition 1: Whichever unitary transformation is performed, in measurement after the transformation, there is no measured value range including only the state assigned to specific information;
Condition 2: Whichever unitary transformation is performed, in measurement after the transformation, there is no measured value range including only the state assigned to specific base; and
Condition 3: When the measurement is performed after a specific unitary transformation corresponding to the base, there is a measured value range including only the state assigned to recorded information,
wherein the selection is performed based on the information to be recorded prepared in the first step and the base determined from the reading key and the algorithm;
a third step of creating the quantum state selected in the second step on a recording medium;
a fourth step of storing the quantum state created in the third step on the recording medium;
a fifth step of delivering the recording medium storing the quantum state of the fourth step to an authorized information user and disclosing the reading key;
a sixth step of determining the base of each bit from the disclosed reading key, and performing the unitary transformation corresponding to the base to provide the measured value range including only the state assigned to the recorded information; and
a seventh step of measuring the quantum ensemble state having undergone the sixth step and obtaining a measurement result corresponding to the recorded information.

5. A recording/reproducing method of information comprising:
a first step of preparing:
information to be recorded;
information that is called a reading key,
wherein a person who knows the information can specify a base used for recording each bit and a person who does not know the information cannot specify the base; and
an algorithm for determining the base of each bit from the reading key;
a second step of selecting a quantum ensemble state to be created in each bit from a set of quantum states selected so as to satisfy three following conditions:
Condition 1: Whichever physical quantity is measured, there is no measured value range including only the state assigned to specific information;
Condition 2: Whichever physical quantity is measured, there is no measured value range including only the state assigned to specific base; and
Condition 3: When a specific physical quantity corresponding to the base is measured, there is a measured value range including only the state assigned to recorded information,
wherein the selection is performed based on the information to be recorded prepared in the first step and the base determined from the reading key and the algorithm;
a third step of creating the quantum state selected in the second step on a recording medium;
a fourth step of storing the quantum state created in the third step on the recording medium; and
a fifth step of determining the base of each bit from the reading key, measuring the physical quantity corresponding to the base, and obtaining a measurement result corresponding to the recorded information.

6. A recording/reproducing method of information comprising:
a first step of preparing:
information to be recorded;
information that is called a reading key,
wherein a person who knows the information can specify a base used for recording each bit and a person who does not know the information cannot specify the base; and
an algorithm for determining the base of each bit from the reading key;
a second step of selecting a quantum ensemble state to be created in each bit from a set of quantum states selected so as to satisfy three following conditions:
Condition 1: At an arbitrary phase time, either of a region in which measured value is inevitably positive and a region where measured value is inevitably negative can include states assigned to 0 and 1;
Condition 2: At an arbitrary phase time, either of a region in which measured value is inevitably positive and a region where measured value is inevitably negative can include states assigned to bases A and B; and
Condition 3: A phase time period when one of a region where measured value is positive and a region where measured value is negative includes only the state assigned to 0 and the other includes only the state assigned to 1 inevitably exits when a base is specified,
wherein the selection is performed based on the information to be recorded prepared in the first step and the base determined from the reading key and the algorithm;
a third step of creating the quantum state selected in the second step on a recording medium;
a fourth step of storing the quantum state created in the third step on the recording medium; and
a fifth step of determining the base of each bit from the reading key, performing measurement at the phase time period corresponding to the base, and obtaining a measurement result corresponding to the recorded information.
